(19) United States
(12) Patent Application Publication
(10) Pub. No.: US 2024/0159672 A1
(43) Pub. Date: May 16, 2024

(54) System and Method For Analyzing Biological Material

(71) Applicant: Agilent Technologies, Inc., Santa Clara, CA (US)

(72) Inventor: Robert C. Taber, Santa Clara, CA (US)

(21) Appl. No.: 18/549,631

(22) PCT Filed: Mar. 14, 2022
(86) PCT No.: PCT/US2022/020122

§ 371 Date: Sep. 8, 2023

Related U.S. Application Data
(60) Provisional application No. 63/160,841, filed on Mar. 14, 2021.

(51) Int. Cl. G01N 21/64; G01N 21/77

(52) U.S. Cl. CPC G01N 21/6408; G01N 21/6428; G01N 2021/6439; G01N 2021/7786

(57) ABSTRACT

A system and process is disclosed for measuring a fluorophore in a sample, such as a sample of a biological material. The process and system is particularly well suited to measuring fluorescent lifetimes of many different biological parameters. The system includes a time-of-flight sensor that can operate at a modulation rate capable of measuring fluorescent lifetimes that are extremely short, such as lasting only a few nanoseconds. Although the system and process have broad applicability, the system and process are particularly well suited for measuring metabolic characteristics of cells, such as pH, oxygen, and temperature.

### RELATED APPLICATIONS

The present application claims priority to U.S. Patent Application Ser. No. 63/160,841, filed on Mar. 14, 2021, the entire contents of which are incorporated herein by reference.

### BACKGROUND

Biomedical analysis and imaging plays a role in a large number of diagnostic and therapeutic procedures including visualizing external and internal anatomical and physiological structures, features, and systems and evaluating complex biological events in the body at the organ, tissue, cellular, and molecular levels. Biological and cellular analysis allows physicians and other health care professionals to detect and diagnose the onset of disease, injury, and other disorders at an early stage and to accurately monitor progression or remission of a condition. Biological and cellular analysis can also facilitate the delivery of targeted and minimally invasive therapies for treating and managing a range of conditions. A large number of applications of biological analysis have matured into robust, widely used clinical techniques.

In some applications, the analysis of biological materials, such as cells and tissues, includes generating images or signals by detecting electromagnetic radiation, nuclear radiation, acoustic waves, electrical fields, and/or magnetic fields transmitted, emitted and/or scattered by materials. Modulation of energy (e.g., radiative, acoustic, etc.) and/or particles provided to a sample via interaction with materials such as biological molecules and tissue structures yields patterns of transmitted, scattered or emitted radiation acoustic waves, electrical fields or magnetic fields that contain useful anatomical, physiological, and/or biochemical information. Modulation may occur via mechanisms involving interactions of endogenous materials in the sample and/or mechanisms involving interactions of exogenous imaging agents introduced to a sample to enhance the usefulness of the acquired image or signal, such as contrast agents, dyes, optically or radiolabel materials, biomarkers, and other agents. Various different biomedical instruments have been demonstrated as generally useful for providing images of surface and subsurface components of tissue samples and also provides a means of real time monitoring of components of biological samples, in vivo and in vitro.

Biomedical imaging and analysis techniques are particularly well suited in assay devices. An assay is a qualitative and/or quantitative analysis of an unknown analyte. In one aspect, for instance, an assay device can be used to conduct an analysis of the type and concentration of an analyte contained in a cellular sample, such as a biopsy. These types of devices are well suited to analyzing living cells and providing useful information regarding the metabolic processes that are occurring inside the cells. For instance, the devices can provide real-time cell analyte measurements that provide a clear window into the critical functions driving cell signaling, proliferation, activation, toxicity, and biosynthesis. More particularly, these devices can generate a metabolic phenotype in a relatively short amount of time.

### SUMMARY

Light Detection And Ranging (“LiDAR”), which uses time-of-flight sensors, detects surrounding objects and captures their distance to the sensor by emitting a very short light pulse and measuring the time that the light travels from the sensor to the object and back. LiDAR is a key technology for several applications including autonomous vehicles, intelligent transportation system, drone, sweeping robot and others. Automotive manufacturers worked with LiDAR sensors to develop advanced technologies for self-driving cars. LiDAR technology can generate a three dimensional point cloud in real time of the vehicle's surroundings under all kinds of weather conditions.

The present disclosure is generally directed to incorporating portions of LiDAR technology into the interrogation of fluorescence lifetimes in a unique and novel way for use, for example, in the biopharma industry and in biopharma applications. The present disclosure describes and demonstrates the use of a time-of-flight sensor in a biological system and device for making measurements of a response agent such as a fluorophore responding in a nanosecond scale to changes in pH, or for measuring changes in any biological material that can respond in the same nanosecond scale. Applicants have demonstrated that these measurements can be made in a nanosecond time scale allowing reliable and accurate measurements of one or more response agents, such as a fluorophore or any biological material, that previously could not be measured.

Additionally, as the cost of LiDAR sensors declines, using LiDAR in biological devices and systems offers a cost effective solution for making nanosecond lifetimes measurements of biological samples.

Accordingly, in one embodiment, the present disclosure is directed to a system for analyzing a biological material. The system optionally includes a sample staging site for the biological material. The biological material, for instance, can be any material containing a constituent to be tested, monitored or mapped. The biological material can be cellular material. The biological material, for instance, can be living cells. In accordance with the present disclosure, the system further includes a light source configured to emit excitation light onto the biological material contained on the sample staging site. The excitation light has a wavelength that causes a constituent associated with the biological material to undergo a luminescent emission, such as a fluorescent emission or phosphorescent emission. As used herein, a constituent is any component contained in or associated with the biological sample. The constituent alone may produce the luminescent emission or the luminescent emission may be produced by a fluorophore that is influenced by the constituent. An optical communication path is positioned to obtain an optical signal indicative of the luminescent emission, such as a fluorescent emission or phosphorescent emission, associated with the constituent of the biological material positioned on the sample staging site. A time-of-flight sensor comprising a plurality of pixels is configured to receive the signal indicative of the luminescent, fluorescent, or phosphorescent emission from the optical communication path. Each pixel or group of pixels of the plurality of pixels are configured to provide a signal associated with a photo-response of the pixel or group of pixels based at least in part on the optical signal. The system further includes one or more processors in communication with the time-of-flight sensor. The one or more processors are configured to determine or map a characteristic of the biological material from the luminescent emission. For example, a fluorescent lifetime or a fluorescent intensity can be determined of the constituent based at least in part on the photo-response of each pixel or group of pixels. The one or more processors can be configured to determine the presence of the constituent and/or determine a magnitude characteristic of a parameter related to the constituent from the fluorescent lifetime or the fluorescent intensity.

The system of the present disclosure can be incorporated into any suitable system designed to examine biological materials including systems that examine live cells. For example, the system of the present disclosure using a time-of-flight sensor can be incorporated into all types of cell metabolic analysis systems, microfluidic systems, microplate readers, multimode and absorbance readers, and imaging systems such as fluorescence lifetime imaging microscopy (FLIM) systems.

In one aspect, at least a portion of the optical communication path and the time-of-flight sensor can be a CMOS time-of-flight sensor designed for implementation as part of a Light Detection and Ranging (LiDAR) subsystem. The optical communication path can comprise at least one light pipe or at least one fiber optic. A light source can be configured to emit a coherent beam of light. For instance, the light source can be a laser, a laser diode, or a light emitting diode. The light source can be configured to emit the excitation light in pulses or as a sinusoid at a modulation rate in order to measure fluorescent lifetimes. The modulation rate can be determined at least in part on a decay time of the fluorescent emission or phosphorescent emission associated with the constituent of the biological sample. For example, the modulation rate can be from about 0.01 MHz to about 1,000 MHz, such as from about 25 MHz to about 200 MHz. The decay time or fluorescent lifetime of the constituent being tested can be generally less than one second, such as less than about 1000 microseconds. The system of the present disclosure is particulary well suited to detecting extremely short fluorescent lifetimes in a very efficient matter. For example, in one embodiment, the system can detect and measure fluorescent lifetimes of less than about 20 nanoseconds, such as less than about 10 nanoseconds, such as less than about 5 nanoseconds, such as less than about 3 nanoseconds, such as less than about 2 nanoseconds, and generally greater than about 0.001 nanoseconds. The modulation rate can be optimized according to the fluorophore. As the modulation rate is optimized, the accuracy of the measurement is improved. Measurement performance can be further improved by tuning the modulation rate to match the characteristics of the fluorophore or sensor, or the requirements of the application.

The signal indicative of the photo-response can comprise a signal indicative of a response phase for the pixel. The response phase for the pixel, for instance, can be determined based at least in part by performing operations that includes determining a first response for the pixel from a first analog integrator; determining a second response for the pixel using a second analog integrator; and determining the response phase based at least in part on the first response and the second response.

In one embodiment, each pixel in the time-of-flight sensor can be configured to receive fluorescent emissions or phosphorescent emissions from the optical communication path in phase with the light source such that the pixels only receive the fluorescent emissions or phosphorescent emissions after the biological material has been exposed to a pulse of light and prior to being exposed to a subsequent pulse of light.

In one embodiment, the system includes a plurality of sample staging sites where each sample staging site is associated with an optical communication path. The pixels of the time-of-flight sensor are divided into a plurality of zones. Each optical communication path of each sample staging site can be in communication with at least one of the plurality of zones. The time-of-flight sensor and one or more processors are configured to receive fluorescent emissions or phosphorescent emissions from each sample staging site and determine the fluorescent lifetime or the fluorescent intensity of a constituent from each sample staging site. The system can include, for instance, at least 5 sample staging sites, such as at least 10 sample staging sites, such as at least 50 sample staging sites, such as at least 75 sample staging sites, such as at least 100 sample staging sites, and up to about 5,000 sample staging sites. For example, the plurality of sample staging sites can be contained in a microplate or cell-plate. In some embodiments, the sample staging site may be contained on a glass slide, a sensor array, a silicon chip, a microarray, or a microfluidic device. In particular embodiments, the microfluidic device may comprise a series of parallel or interconnected channels, wherein each channel comprises one or more staging sites. In some embodiments, the sample stating sites may be contained in a well plate, such as a 6-well plate, a 24-well plate, a 96-well plate, a 384-well plate, a 1536-well plate, and the like.

The system can further comprise an array of plungers or probes that move relative to the microplate. The plungers are spaced apart so as to align with the sample staging sites on the microplate. The plungers are stationary or are configured to move towards the sample staging sites for being placed in proximity to the biological sample located on the sample staging sites. The plungers can be in communication with the optical communication path for delivering the excitation light to the biological material and for delivering the s produced by the biological material to the time-of-flight sensor.

In one embodiment, the system can also include a fluorescent agent or fluorophore source for supplying at least one fluorophore to the biological material. The fluorophore, in one embodiment, can be in communication with a quenching agent. The fluorophore source, for instance, can be located on the plunger or probe that is placed in communication with the biological material. Alternatively the fluorophore source can be located in the biological material sample. The biological material may comprise cells and the fluorophore may be located in the cells or may be located in a fluid surrounding the cells. In one embodiment, the fluorophore may comprise nanoparticles or microparticles that are coupled to the plunger or probe, are in a suspension surrounding the cells, or are in a solution surrounding the cells.

In one aspect, the biological material can be placed in communication with different fluorophores for measuring different constituents simultaneously. In fact, the system is capable of not only taking measurements of a plurality of biological samples simultaneously but is also capable of further measuring more than one constituent in each biological sample simultaneously. In some embodiments, the fluorophore is supplied by the cellular material itself, i.e. the cellular material may be autofluorescent. In some embodiments, the fluorophore is added to the cellular material, or to the solution or material in contact with the cellular material. In some embodiments, the fluorophore may be a protein, such as a fluorescent protein, which is expressed in the cell. In some embodiments, the fluorophore may be bound to a protein, or it may exist in protein-bound and unbound states in the cell. In some embodiments, the fluorophore may be attached to an antibody or other affinity reagent, which binds to proteins or other constituents inside the cell or on the cell surface.

Example aspects of the present disclosure are also directed to a method for analyzing biological material. The method includes exposing biological material that includes at least one fluorophore to excitation light in a manner that causes the fluorophore to undergo a fluorescent emission or phosphorescent emission. The fluorescent emission or phosphorescent emission is communicated to and sensed by a time-of-flight sensor. A fluorescent lifetime or a fluorescent intensity of the analyte is determined. In one aspect, the method can include not only verifying the presence of the analyte but also determining a magnitude characteristic of the analyte from the fluorescent lifetime or the fluorescent intensity. In one aspect, the method can include inferring a characteristic of the environment of the fluorophore (e.g., bound or unbound state, or proximity to a quencher) from the fluorescent lifetime or the fluorescent intensity.

The biological material being tested can comprise a cellular material. The biological material can contain living cells comprising bacteria cells, fungus cells, yeast cells, prokaryotic cells, eukaryotic cells, enzymes, or the like. The cells can be animal cells, human cells, immune cells, or immortal cells. In some aspects, the cellular material may comprise material derived from cells, such as a cellular lysate. In some aspects, the cellular material may comprise components of cells, such as proteins, enzymes, organelles such as mitochondria or chloroplasts. In some aspects, the cellular material may comprise material derived from cells infected with a pathogen, such as a virus, fungus, or bacterium. The constituent or parameter being measured can be a dissolved gas, an ion, a protein or a polypeptide, a metabolite, a nucleic acid, a lipid, a substrate, an oxidation state, a viscosity, a salt, a mineral, or combinations thereof. Dissolved gases that can be measured include oxygen, carbon dioxide, nitric oxide, or ammonia. The constituent can be contained within the cell or can comprise a material secreted by the cells into the surrounding media.

Particular constituents or parameters related to the constituent that may be measured include oxygen, pH, or temperature. The constituent can be directly related to the parameter of interest (e.g. be the same) or can be a characteristic related to the parameter that allows for determination of the parameter. In one embodiment, the fluorescent lifetime of a pH characteristic is measured. The fluorescent lifetime can be extremely short, such as less than about 20 nanoseconds, such as less than about 15 nanoseconds, such as less than about 10 nanoseconds, such as less than about 5 nanoseconds, such as even less than about 2 nanoseconds. In other embodiments, the fluorescent lifetimes may be longer, such as longer than 20 nanoseconds, longer than 100 nanoseconds, longer than 500 nanoseconds, longer than a microsecond, or longer than 25 microseconds. The skilled artisan will appreciate that the range of fluorescent lifetime will depend on the particular fluorophore.

The constituent being examined can be autofluorescent or can be placed in association with one or more fluorophores for producing a fluorescent emission or phosphorescent emission. For example, the analyte being measured may comprise the intrinsically fluorescent metabolic cofactors nicotinamide adenine dinucleotide (NAD⁺/NADH), NAD(P)H, and flavin adenine dinucleotide (FAD/FADH₂). In some aspects, the constituent or parameter being measured may comprise another intrinsically fluorescent molecule in the cell, such as a protein, lipid, nucleotide, or metabolite. For example, FLIM systems may be used to investigate the lifetime of fluorophores in lipid bilayers, giving information about membrane fluidity or lipid microdomains such as lipid rafts.

The method can further include the step of determining the fluorescent lifetime of a plurality of constituents from the same sample of biological material simultaneously or near simultaneously. Multiple samples of biological material can also be measured simultaneously or near simultaneously.

Other features and aspects of the present disclosure are discussed in greater detail below.

### BRIEF DESCRIPTION OF THE DRAWINGS

A full and enabling disclosure of the present disclosure is set forth more particularly in the remainder of the specification, including reference to the accompanying figures, in which:

FIG. 1 is for exemplary purposes only and illustrates one embodiment of a system for analyzing biological material in accordance with example embodiments of the present disclosure;

FIG. 2 is a cross-sectional view of the system illustrated in FIG. 1;

FIG. 3 is a block diagram illustrating the differences between fluorescent intensity measurements and fluorescent lifetime measurements according to examplary embodiment of the present disclosure;

FIG. 4A is a diagrammatical view of one embodiment of a system made in accordance with examplary embodiments of the present disclosure;

FIG. 4B is another diagrammatical view of one embodiment of a system made in accordance with examplary embodiments of the present disclosure;

FIG. 4C is still another diagrammatical view of one embodiment of a system made in accordance with examplary embodiments of the present disclosure;

FIG. 5 is a diagrammatical figure illustrating an illumination control signal in combination with phase modulation of a sensor according to example embodiments of the present disclosure;

FIG. 6 is an exploded, perspective view of example embodiments of a microplate that may be used in accordance with the present disclosure for testing biological samples;

FIG. 7 is an inverted and exploded, perspective view of the microplate illustrated in FIG. 6;

FIG. 8 is a cross-sectional view of one embodiment of a biological sample contained in a sample staging site in association with a probe or plunger and one or more component ports for taking measurements in accordance with example aspects of the present disclosure;

FIG. 9 is a flow diagram of an example process according to example embodiments of the present disclosure;

FIG. 10 is a perspective view of another embodiment of a microplate that may be used in accordance with the present disclosure for testing biological samples;

FIG. 11 is a cross-sectional view of one embodiment of a probe or plunger for taking measurements in accordance with example aspects of the present disclosure;

FIG. 12 is a cross-sectional view of another embodiment of a probe or plunger for taking measurements in accordance with example aspects of the present disclosure;

FIG. 13 is a cross-sectional view of one embodiment of a microfluidic system in accordance with exemplary embodiments of the present disclosure;

FIG. 14 is a plan view of one embodiment of a microfluidic system in accordance with exemplary embodiments of the present disclosure;

FIG. 15 are perspective views of three dimensional analyses that may be conducted in accordance with the present disclosure; and

FIG. 16 is a graphical representation of the results obtained in the example below.

Repeat use of reference characters in the present specification and drawings is intended to represent the same or analogous features or elements of the present invention.

### DETAILED DESCRIPTION

It is to be understood by one of ordinary skill in the art that the present discussion is a description of exemplary embodiments only and is not intended as limiting the broader aspects of the present disclosure.

Example aspects of the present disclosure are directed to a process and system for analyzing one or more biological constituents, including cellular parameters, contained in or associated with a biological material sample, such as a cell culture. The process and system utilize light detection and ranging components in a manner that not only efficiently takes readings, but also can take faster measurements than many conventional systems.

The system of the present disclosure can be incorporated into any suitable system designed to examine biological materials including systems that examine live cells. For example, the system of the present disclosure using a time-of-flight sensor can be incorporated into all types of cell metabolic analysis systems, microfluidic systems, microplate readers, multimode and absorbance readers, and imaging systems such as fluorescence lifetime imaging microscopy (FLIM) systems.

One particular device that has made great advances is the SEAHORSE analysis platform that is manufactured and sold by Agilent Technologies. The SEAHORSE analysis platform, for instance, can make quantitative measurements of mitochondrial function and cellular bioenergetics. For example, the instrument can measure oxygen concentration and pH in the extracellular media of a cell based assay. Different aspects of the SEAHORSE analysis platform are described in U.S. Pat. No. 7,276,351, U.S. Pat. No. 7,638,321, U.S. Pat. No. 8,697,431, U.S. Pat. No. 9,170,253, U.S. Patent Publication No. 2014/0170671, U.S. Patent Publication No. 2015/0343439, U.S. Patent Publication No. 2016/0077083, and U.S. Patent Publication No. 2016/0096173, which are all incorporated herein by reference. The process and system of the present disclosure can be incorporated into the above described devices for providing various advantages and benefits. For example, the above instrument makes measurements based on light intensity, which requires that the light source be calibrated at regular intervals. The system and process of the present disclosure, however, can not only take measurements based on light intensity, but can also take measurements based on luminescent lifetimes that eliminate the need for repeated calibrations. The system and process of the present disclosure can also increase speed and take more rapid measurements without significant added cost.

The system and process of the present disclosure can also be incorporated into microplate readers including multimode and absorbance readers. For example, the detection system of the present disclosure can be incorporated into various exemplary devices including the SYNERGY Hybrid Multimode Readers, the CYTATION Hybrid Multimode Reader, the LOGPHASE Microbiology Readers, the EPOCH Microplate Spectrophotometers, the ELx808 Absorbance Reader, and the 800 TS Absorbance Reader all available through Agilent Technologies.

The present disclosure is also directed to fluorescence lifetime imaging microscopy (FLIM) systems. FLIM systems are image-based systems that can determine the differences in the exponential decay rate of a fluorophore emission from a sample. Images can be produced according to the present disclosure that can be used to determine molecular oxygen mapping, determine different deoxygenating kinetics at different locations, and/or determine and image enzyme activity including the activity of L-amino-acid oxidase. In some aspects, FLIM systems can be used to measure Förster/Fluorescence Resonant Energy Transfer (FRET) between donor and acceptor fluorophores or a fluorophore and a quencher. As FRET can cause changes in the fluorescence lifetime, lifetime measurements can be used to measure proximity or orientation of a FRET donor-acceptor pair. FLIM-FRET systems can be used to measure biological processes such as protein-protein interactions, receptor dimerization, receptor-ligand interactions, or the interactions of fluorophores with cellular structures such as membranes, nucleic acids, lipids, glycans, or cytoskeletal elements.

The present disclosure is also directed to microfluidic systems that can include lab-on-a-chip and organ-on-a-chip systems. In microfluidic systems, the microfluidic device may comprise a series of parallel or interconnected channels, wherein each channel comprises one or more staging sites for biological testing. Testing may occur while the microfluidic system is a perfusion mode, such that a living cell sample is continuously being fed a cell media. An exemplary system is disclosed in U.S. Pat. No. 8,858,886, which is incorporated herein by reference. One type of analysis performed in microfluidic systems is polymerase chain reaction (qPCR) that may be used in DNA sequencing, DNA cloning, gene mapping, and other forms of nucleic acid sequence analysis. In general, qPCR relies on the ability of DNA-copying enzymes to remain stable at high temperatures. A specimen containing DNA molecules is placed in one or more wells of a microplate together with various reagents including a DNA-binding fluorescent dye. The well plate is heated to break the bonds between the two strands that constitute the DNA molecules in the specimen. The well plate is next cooled so primers can bind to the ends of the strands. Finally, the well plate is heated and nucleotides are added to the primers and eventually a complementary copy of the DNA template is formed. Binding to the DNA molecule activates the fluorescent dye. Consequently, the intensity of the emission light output by the activated fluorescent dye provides a measure of the amount of the fluorescent dye that has been activated, and, hence, the number of DNA molecules that have been produced.

The present disclosure is also directed to cytometer systems. Flow cytometry is a laser-based, biophysical technology where fluorescent molecules coupled to cells are passed through a flow cell and excited by light sources, such as a set of lasers. The fluorescence is collected and separated into different channels with specific detection wavelength, converted to electrical signals, and analyzed using a processor. Multi-color flow cytometry, such as three color flow cytometry uses fluorophores with different excitation and emission wavelengths for identification of different staining of the biological samples. More specifically, the excitation light may be delivered to the flow cell by beam-shaping, steering, and guiding optical components. In time-resolved flow cytometry, the fluorescence lifetime of the fluorophores can be measured. Different fluorophores for flow cytometry are often chosen for differences in quantum yield or other chemical characteristics, but flow cytometry fluorophores may also be chosen for fluorescent lifetimes enabling time-resolved flow cytometry. A cytometer system is disclosed in U.S. Pat. No. 9,575,063, which is incorporated herein by reference. For the purpose of measuring fluorescent lifetime in a flow cytometry instrument, the exposure time will necessarily be quite short, but LIDAR measurements are routinely made with integration intervals of less than 1 millisecond. In order to capture both phases in a single exposure, an optical delay line utilizing optical fibers (in one embodiment) can be used to feed a delayed optical signal to a portion of the imaging array while the rest of the array captures an undelayed portion of the signal. In addition, in one embodiment, samples can be labeled with multiple dyes for simultaneous analysis of samples.

The present disclosure is directed to a time-of-flight sensor module that can be added to any spectroscopic instrument that can produce enough signal when light passes through the biological sample held within a container such as a cuvette to measure fluorescence intensity, and/or fluorescence lifetime of the sample. The LiDAR module can also be used to measure absorbance, transmittance, and fluorescence polarization. Examples of spectroscopic instruments include, but are not limited to spectrometers, spectrophotometers, and fluorometers. The time-of-flight module can also be similarly incorporated into scanning microscopy systems. Example aspects of the present disclosure are directed to detection systems and processes that incorporate time-of-flight sensors, such as CMOS time-of-flight sensors that have been found to increase measurement speed in an extremely accurate way. In some embodiments, the time-of-flight sensors can be CMOS time-of-flight sensors designed for use in, for instance, Light Detection and Ranging (LiDAR) systems.

The time-of-flight sensors, for instance, can accurately measure a response phase (e.g., an in phase response and/or a quadrature response) of fluorescent emissions or phosphorescent emissions to modulated light signals. The response phase can be used to determine characteristics of the fluorescent emissions, such as fluorescent intensity and/or fluorescent lifetimes of well below 20 nanoseconds. Consequently, the systems and processes according to example aspects of the present disclosure are capable of measuring extremely short fluorescent events that were difficult of being detected by many prior instruments.

The systems and processes according to example aspects of the present disclosure can be well suited to measuring constituents in all different types of samples, such as biological samples. In one aspect, for instance, the systems and processes according to example aspects of the present disclosure can be used to measure one or more constituents or a parameter related to the constituent in cellular material. The one or more constituents may be contained in a medium surrounding the cells or can be contained within the cells themselves. In some embodiments, the biological sample being tested may contain cellular material derived from cells, such as cellular organelles, mitochondria, or cellular extracts. Of particular advantage, the measurements can be completed in a label-free manner.

Due to increased speed of taking measurements, the systems and processes according to example aspects of the present disclosure are particularly versatile. For example, the systems and processes incorporate a time-of-flight sensor, that can operate at frequencies capable of making measurements of timed events that last only a few nanoseconds. For example, in one aspect, the time-of-flight sensor can use sinusoidal modulation and measure the phase of the response at frequencies much greater than 20 MHz, such as greater than about 50 MHz, such as greater than about 70 MHz, such as greater than about 100 MHz. For example, when operating at 100 MHz, the time-of-flight sensor can measure responses that last less than 2 nanoseconds.

The systems and processes according to example aspects of the present disclosure can measure fluorescent responses for conducting assays on biological parameters. The systems and processes according to example aspects of present disclosure can not only operate by measuring the intensity of the fluorescent emission or phosphorescent emission but can also be well suited to measuring fluorescent lifetimes. Although intensity measurements may be preferred in certain situations, the ability to measure fluorescent lifetimes can provide various advantages and benefits. The system and process of the present disclosure is also well suited to producing images and conducting image analysis. In addition, the process and system of the present disclosure can also conduct three dimensional analysis of constituents contained in a biological sample or of biological parameters related to the constituents.

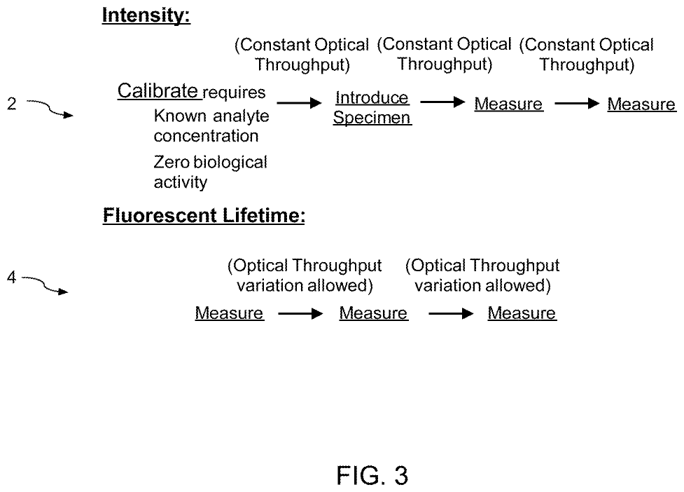

For instance, referring to FIG. 3, a comparison is illustrated between taking intensity measurements and fluorescent lifetime measurements. When taking intensity measurements according to diagram 2, for instance, a calibration of the instrument occurs prior to taking measurements in order to quantify the optical throughput. The calibration is typically conducted using a known analyte concentration in the absence of any biological activity. The calibration step is conducted not only to quantify optical throughput for the measurement device but also for the fluorophore present. Once the calibration has been completed, a specimen, such as a biological specimen, can be introduced into a sample staging site for measuring one or more constituents.

As shown in FIG. 3, when measuring fluorescent lifetime (diagram 4), on the other hand, the calibration step is not only eliminated but measurements can be conducted without having uniform optical throughput. Thus, not only can biological specimens be measured for one or more constituents but alternative assays can be conducted using the instrument without the delays associated with calibration. The process and system of the present disclosure also provides more robust conversion of signal to measurement with less requirement for optical coupling. These advantages are realized at low cost and without adding significant complexity.

In the past, many similar instruments were limited to only making intensity measurements due to limitations on throughput and measurement speeds. As described above, however, incorporating a time-of-flight sensor into the systems and processes according to example aspects of the present disclosure allows for fluorescent lifetime measurements, even when the fluorescent lifetimes are less than a few nanoseconds. For instance, the fluorescent lifetimes of many pH sensors or fluorophores are in the realm of a few nanoseconds. Accurate pH readings, including accurate pH changes over time, are particularly important in many biological assays. The systems and processes according to example aspects of the present disclosure can provide the opportunity for accurately and directly measuring fluorescent lifetimes related to pH. In addition, the systems and processes according to example aspects of the present disclosure can also be capable of multiplexing fluorescent lifetime measurements in order to perform measurements, such as pH measurements, on a significant number of samples simultaneously. In another embodiment, the system and processes can be used for direct lifetime measurement, or hybrid lifetime measurements using direct and multiplexing fluorescent lifetimes.

In some embodiments, a biological sample, such as cellular material, can be auto-fluorescent (e.g. a fluorophore itself) or optionally, the biological sample can be placed in association with a fluorophore. The fluorophore is originally in a ground state. The fluorophore and sample are then subjected to excitation light (e.g., modulated excitation light) emitted by any suitable light source. The fluorophore absorbs the light, thereby increasing its energy level until the fluorophore reaches a high-energy excited state. Because the fluorophores are unstable in the high-energy, excited state, during an excited lifetime process, the fluorophores lose some of its energy and adopt a lower energy excited state to become semi-stable. During an emission process, the fluorophore releases its excess energy by emitting light until the fluorophore returns to its ground state. The amount of energy released can be dependent upon the presence and/or amount of a constituent present in association with the biological sample.

The intensity of the fluorescent emission or phosphorescent emission decays at a substantially exponential rate until the ground state is reached. The lifetime, τ, of a fluorophore is referred to as the time the molecule ‘lives’ in its excited state before emitting a photon. Fluorescence obeys a first-order kinetic mechanism as its intensity decays exponentially according to:

I(t)=I₀e^{-t/τ}

Lifetime relates to the time for the fluorescent intensity to decay to 1/e or 36.7% of the original intensity. The value of this lifetime for many fluorophores is in the sub-nanosecond to tens of nanosecond range, to microsecond range and is a function of its chemical structure, which can be affected by the environment of the fluorophore including the proximity of quenching or fluorescent enhancing reagents.

The fluorescent lifetime of a fluorophore molecule is indicative of the average time the molecule remains in the excited state prior to its return to the ground state. Lifetime data, as it is related to decay rates from the excited state to the ground state, can reveal a number of different types of information, such as the frequency of collisional encounters with a quenching agent, the rate of energy transfer, and the rate of excited state reactions, such as photo-induced electron transfer. The precise nature of these fluorescent decays in a biological sensor system can further reveal details about the interaction of the fluorophore molecule with its environment. For example, multiple decay constants can be a result of the fluorophore molecule being in several distinct environments, such as the molecule being bound of being free, and/or a result of excited state processes, such as photo-induced electron transfer.

Example methods for the measurement of fluorescent lifetimes are the pulse method (also known as time-resolved fluorometry) and the harmonic or phase-modulation method. In the pulse method, the sample is excited with a brief pulse of light and the time-dependent decay of fluorescence intensity is measured. In the harmonic method, the sample is excited with sinusoidally modulated light. In this method, the phase shift and demodulation of the emission, relative to the incident light, is used to calculate the lifetimes.

As described above, although the systems and processes according to example of the present disclosure can make intensity measurements, the option of also making fluorescent lifetime measurements can offer various advantages. Fluorescent lifetime measurements, for instance, are independent of many experimental parameters, such as sample concentration and volume, excitation intensity and experimental geometry. The system of the present disclosure, incorporating LiDAR components, can increase optical coupling efficiency. In addition, the system increases the efficiency of the transmissiveness of the system components, decreases sample turbidity and possesses inherent inner-filter properties.

In accordance with the present disclosure, time-of-flight sensors (e.g., CMOS time-of-flight sensors) can be used to significantly improve biological measuring systems. More particularly, the systems and processes according to example aspects of the present disclosure incorporate a time-of-flight sensor to receive fluorescent emission or phosphorescent emission signals and to process the signals quickly and efficiently. Further, a single time-of-flight sensor can include a pixel array containing thousands of pixels with the capability of measuring the phase of a modulated light signal over a broad range of modulation frequencies. In this manner, not only is the time-of-flight sensor capable of making rapid measurements of very short fluorescent emissions or phosphorescent emissions, but is also configured to make a significant number of measurements simultaneously or near simultaneously of a single fluorophore or constituent or of multiple fluorophores or constituents. The time-of-flight sensor is also capable of measuring phase with remarkably low added noise. In essence, the systems and processes of the present disclosure incorporate a time-of-flight sensor designed to measure the delayed arrival of a reflected light signal and applies it to the measurement of the prompt decay of a fluorescent signal. More particularly, in one aspect, the time-of-flight sensor is designed to receive a fluorescent emission or phosphorescent emission that is relatively large in magnitude and then measure the time it takes for the signal to decay. Alternatively, the time-of-flight sensor can also measure optical intensity if desired.

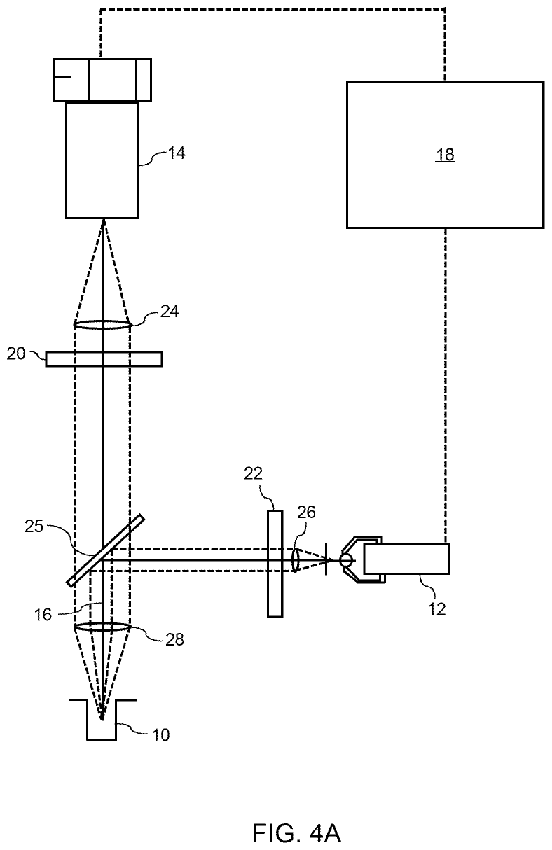

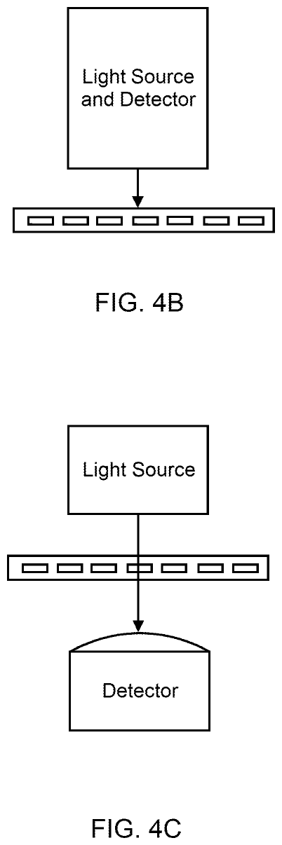

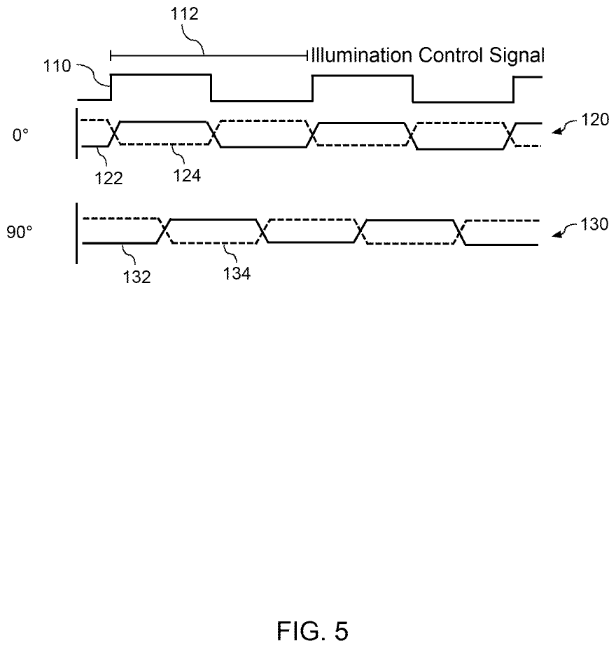

Referring to FIG. 4A, for example purposes, a simplified diagram of one embodiment of a system made in accordance with the present disclosure is shown. As illustrated in FIG. 4A, the system includes a sample staging site 10 that is positioned to receive excitation light from a light source 12. The light source 12 emits excitation light (e.g., modulated excitation light, such as a sinusoid or a series of pulses) that causes a fluorophore associated with a sample on the sample staging site 10 to undergo a fluorescent emission or phosphorescent emission. The fluorescent emission or phosphorescent emission is then sensed by a time-of-flight sensor 14, such as a CMOS time-of-flight sensor. The fluorophore can be a constituent contained in the biological sample naturally or can be added to the biological sample and be influenced by a constituent present in the biological sample.

The system further includes an optical communication path 16. The optical communication path is for directing the excitation light emitted by the light source 12 onto the sample staging site 10 and for directing a corresponding fluorescent emission or phosphorescent emission to the time-of-flight sensor 14. The optical communication path 16 can include fiber optics. However, as discussed below, the optical communication path 16 can include any suitable optical path and/or optical elements for communicating optical signals.

The time-of-flight sensor 14, in one aspect, can include a pixel array comprising a plurality of pixels configured to receive signals from the optical communication path 16. For example, the signal received from the optical communication path 16 can be an optical signal that is indicative of a fluorescent emission or phosphorescent emission that occurred by a fluorophore contained in the sample staging site 10. Each pixel or group of pixels in the pixel array, for instance, can be configured to provide a signal associated with a photo-response of the pixel or group of pixels based at least in part on the optical signal received. In some embodiments, the time-of-flight sensor 14 can be, for instance, an IMX556 time-of-flight sensor manufactured by Sony.

The system can further include one or more processors 18 that can be placed in communication with the time-of-flight sensor 14 and the light source 12. The one or more processors 18 can include, for instance, any suitable processing device, such as one or more microprocessors, integrated circuits (e.g., application specific integrated circuits), CPUs, GPUS, field programmable gate arrays, etc. that perform operations. In some embodiments, the one or more processors 18 can be configured to execute computer-readable instructions stored in one or more memory devices to perform operations, such as any of the operations for determining a response phase, a fluorescent intensity and/or fluorescent lifetime, and/or a magnitude of a characteristic described herein. The one or more memory devices can be any suitable media for storing computer-readable instructions and data. For instance, the one or more memory devices can include random access memory such as dynamic random access memory (DRAM), static memory (SRAM) or other volatile memory. In addition, and/or in the alternative, the one or more memory devices can include non-volatile memory, such as ROM, PROM, EEPROM, flash memory, optical storage, magnetic storage, etc.

The one or more memory devices can store computer-readable instructions that, when executed by the one or more processors 18, cause the one or more processors to perform operations, such as any of the operations implemented by one or more processors described herein. The instructions can be software written in any suitable programming language or can be implemented in hardware.

The one or more processors 18 can be configured to receive signals from the one or more pixels contained in the time-of-flight sensor 14. Based on information received from the time-of-flight sensor 14, the one or more processors 18 can be configured to determine a fluorescent lifetime or a fluorescent intensity of a fluorophore present in the sample staging site 10. In accordance with example aspects of the present disclosure, the one or more processors can be not only used to determine the existence of a biologicalconstituent but can also be configured to determine a magnitude characteristic of the constituent or of a parameter related to the constituent from the fluorescent emission or phosphorescent emission. The magnitude characteristic, for instance, can be an amount, a concentration, a rate of change, or the like. The magnitude characteristic can be mapped in two dimensions or in three dimensions.

As shown in FIG. 4A, the one or more processors 18 can also be in communication with the light source 12. In this manner, the one or more processors 18 can control and coordinate light emissions from the light source 12 in conjunction with sensing fluorescent emissions or phosphorescent emissions using the time-of-flight sensor 14.

As shown in FIG. 4A, the system according to example aspects of the present disclosure can optionally include various different optical elements for directing light onto a sample and/or for directing fluorescent emissions or phosphorescent emissions towards the time-of-flight sensor 14. For instance, the system can include electro-optic modulators, beam-shaping lenses, scanning devices, multi-element lenses, light filters such as interference filters, beam splitters, aperture devices, and the like. For example, as shown in FIG. 4A, the system can include light filters 20 and 22 in combination with lenses 24, 26 and 28. The system can also include a reflecting device 25 for directing light from the light source 12 onto the sample being tested. All of these optical devices, however, are optional and can be eliminated based upon the different equipment used. Optical elements, however, can be helpful for focusing light on a particular area. For instance, if the optical communication path 16 is larger than the sensing or imaging area of the time-of-flight sensor, one or more lenses can be used in order to alter or direct the light. In some embodiments, the optical path can include one or more fiber optics or light pipes.

Light source 12 can generally comprise any suitable light source. For example, the light source 12 can be configured to emit coherent light (e.g., a coherent light beam) or incoherent light. When emitting incoherent light, if desired, one or more filters can be used in order to filter out unwanted wavelengths. The one or more filters may be positioned before the light contacts the biological material for filtering the light being emitted by the light source 12 and/or can be positioned between the biological material and the time-of-flight sensor for filtering the fluorescent emission or phosphorescent emission produced by the fluorophore. Suitable light sources 12 that can be used in the system of the present disclosure include, for instance, light emitting diodes, laser diodes, lasers, and the like. The light source 12 can also comprise one or more of the above light devices. For instance, the light source 12 can comprise a plurality of lasers, light diodes, or light emitting diodes for providing sufficient intensity over a desired area.

The wavelength at which the light source 12 operates can vary depending on the fluorophore present and/or the biological constituent being examined. The wavelength, for instance, can vary from about 250 nm to about 10,000 nm, such as from about 300 nm to about 2000 nm. As used herein, the use of the term “about” in conjunction with a numerical value refers to with 10% of the stated numerical value. The light source 12, for example, may emit ultraviolet light, visible light, near infrared light or mixtures thereof.

The illumination intensity of the light source 12 can depend upon various factors and parameters including the operating wavelength, the sensitivity of the time-of-flight sensor 14, and the signal to noise ratio of the system. In one aspect, the light source 12 can be capable of delivering at least 10² photons per second, such as greater than about 10⁴ photons per second, such as greater than about 10⁸ photons per second, such as greater than about 10⁹ photons per second, such as greater than about 10¹⁰ photons per second, such as greater than about 10¹¹ photons per second, such as greater than about 10¹² photons per second. The light intensity is generally less than about 10³⁰, such as less than about 10²⁰.

The optical communication path 16, in one embodiment, can comprise one or more light pipes or optical fibers. For example, in one embodiment, the optical communication path 16 can include a bundle array of optical fibers. The same optical fibers can be used to deliver light from the light source 12 onto the sample contained on the sample staging site 10 and to communicate a fluorescent emission or phosphorescent emission to the time-of-flight sensor 14. Alternatively, different optical fibers can be used to carry out the different functions.

In one aspect, different optical fibers or different bundled array of optical fibers can be used to direct light onto different zones of sensor elements or pixels located on the time-of-flight sensor. In this manner, multiple measurements can be made simultaneously or near simultaneously from the same sample or different samples contained on the sample staging site 10.

For example, the system is capable of detecting and measuring multiple fluorescent emissions or phosphorescent emissions from different fluorophores contained in the same sample or different samples simultaneously or near simultaneously.

Multiplexing can also be used to measure the same fluorophore in a plurality of samples simultaneously or near simultaneously. For example, in one aspect, the system can include a plurality of sample staging sites. A single light source or multiple light sources can emit light onto each of the sample staging sites simultaneously or near simultaneously. The optical communication path 16 can be used in order to transmit fluorescent emissions or phosphorescent emissions from each sample staging site to different zones of sensor elements or pixels on the time-of-flight sensor 14 for simultaneously making multiple measurements. In fact, the system is capable of measuring fluorescent emissions or phosphorescent emissions from multiple fluorophores in each sample over a plurality of samples simultaneously or near simultaneously. For example, the system can include more than 10 sample staging sites, such as more than 25 sample staging sites, such as more than 50 sample staging sites, such as more than 75 sample staging sites, such as more than 100 sample staging sites, such as more than 125 sample staging sites, such as more than 150 sample staging sites, such as more than 175 sample staging sites, such as more than 200 sample staging sites, such as more than 225 sample staging sites, such as more than 250 sample staging sites, such as more than 300 sample staging sites, such as more than 400 sample staging sites, such as more than 500 sample staging sites and generally less than about 10,000 sample staging sites. In one aspect, the system can include a plurality of time-of-flight sensors in conjunction with one or more light sources for further increasing the number of sample staging sites contained within the system.

In one embodiment, the system of the present disclosure can include light scanning capabilities. For example, as described in U.S. Pat. No. 8,858,886, the system can include a microplate receptacle for receiving a microplate containing biological samples and a stage comprising an optical cartridge receptacle. The optical cartridge receptacle can include a light source and optionally a time-of-flight sensor. At least one of the stage or the microplate receptacle can be movable relative to the other in multiple directions, such as in orthogonal directions. In one embodiment, the system of the present disclosure can include a plurality of windows for optical coupling connected to a single excitation light source and a corresponding number of optical fibers going back to a single pixel array on the time-of-flight sensor for creating a scanning implementation. The number of windows and optical fibers can be from about 4 to about 12, such as from about 6 to about 10.

In one aspect, the time-of-flight sensor 14 can be part of a range imaging system or LiDAR system. Although the time-of-flight sensor 14 may be configured to resolve distances between the sensor and an object for each point of the image by measuring a round trip time of a light signal, the time-of-flight sensor 14, instead of measuring the round trip of a signal, measures the intensity or prompt decay of a fluorescent emission or phosphorescent emission. For instance, when measuring fluorescent lifetimes, the time-of-flight sensor 14 begins a measurement at a fluorescent emission peak and then measures how rapidly the signal fades.

The time-of-flight sensor 14, in one embodiment, can be a modulated light source with one or more phase detectors. For instance, the time-of-flight sensor 14 can operate by modulating a light beam with a carrier and then measuring the phase shift of the carrier. Alternatively, the time-of-flight sensor can be a range-gated imager that has a built-in shutter that opens and closes such that light pulses are emitted by the light source 12.

In the system illustrated in FIG. 4A, the light source 12, the time-of-flight sensor 14, and the one or more processors 18 are shown as separate elements. It should be understood, however, that each of these elements can be incorporated into a single device.

In order to take a measurement or measure a fluorescent emission or phosphorescent emission in accordance with the present disclosure, the system can operate to either measure fluorescent intensity or fluorescent lifetime as shown in FIG. 3. When measuring fluorescent intensity, an initial calibration step may be performed in order to ensure that there is a known optical throughput.

When measuring fluorescent lifetime, a biological sample is first placed on the sample staging site 10 that contains at least one constituent to be sensed, mapped or measured. The constituent can be auto-fluorescent. Alternatively, one or more fluorophores can be placed in association with the sample for generating a fluorescent emission or phosphorescent emission when contacted with light at a desired wavelength. Once the light beam contacts the target flurophore(s), the target flurophore(s) undergoe a fluorescent emission or phosphorescent emission. The fluorescent emission or phosphorescent emission is then communicated via the optical communication path 16 to the time-of-flight sensor 14. The time-of-flight sensor 14 can then measure the fluorescent decay or fluorescent lifetime in conjunction with the one or more processors 18. The signal received by the time-of-flight sensor 14 can be used to not only determine the presence of the constituent but also determine a magnitude characteristic of the constituent if desired.

Although the light source 12 and the time-of-flight sensor 14 can operate using different methods and techniques, in one embodiment, the light source 12 is configured to emit excitation light in pulses at a modulation rate. For instance, the light source 12 can be controlled (e.g., by the one or more processors) to emit excitation light as a raised sinusoid with the bottom of the sinusoid being at zero light emission or near zero light emission. The modulation rate can be selected based at least in part on a decay time of the fluorescent emission or phosphorescent emission of the fluorophore present during testing. For instance, the modulation rate can be anywhere from about 0.01 MHz to about 1,000 MHz, including all increments of 0.01 MHz therebetween. For example, in one aspect, the modulation rate can be greater than about 1 MHz, such as greater than about 10 MHz, such as greater than about 20 MHz, such as greater than about 30 MHz, such as greater than about 40 MHz, such as greater than about 50 MHz, such as greater than about 60 MHz, such as greater than about 70 MHz, such as greater than about 80 MHz, such as greater than about 90 MHz, such as greater than about 100 MHz, such as greater than about 120 MHz, such as greater than about 140 MHz, such as greater than about 160 MHz, such as greater than about 180 MHz, such as greater than about 200 MHz. The modulation frequency, in one aspect, can be less than about 500 MHz, such as less than about 400 MHz, such as less than about 300 MHz, such as less than about 200 MHz, such as less than about 150 MHz.

In one embodiment, the system can use sinusoidal modulation and measure the phase of the fluorescent response. The optimum sensitivity, for instance, can be obtained according to the following relationship:

$$2 π {f}_{mod} = \frac{1}{{τ}_{decay}} .$$

wherein f_{mod} is the modulation and τ_{decay} is the fluorescent lifetime. In this way, the modulation rate of the excitation light emitted by the light source can be determined or selected based at least in part on the fluorescent lifetime of the fluorescent emission or phosphorescent emission.

The photo-response of each pixel in the time-of-flight sensor can be used to determine a fluorescent lifetime of the fluorescent emission or phosphorescent emission. For instance, the response phase of the fluorescent emission or phosphorescent emission to the modulated excitation light can be determined based on the photo-response of each pixel. In some embodiments, the response phase can include both in-phase (I) and quadrature responses (Q) at each pixel. In some embodiments, the fluorescent lifetime can be determined (e.g., by the one or more processors) based at least in part on the following:

$$τ = \frac{1}{2 π fmod} \frac{Q}{I}$$

More particularly, the signal from a collection of fluorophores with a specified decay time can be analyzed as if they come from a simple RC network with the same decay time. The time domain response will be

$$I ( t ) = \frac{1}{τ} {e}^{- \frac{t}{τ}}$$

Where the magnitude has been set to provide unity DC response. The Laplace transform representation will be single pole on the real axis located at

$$\frac{1}{τ} .$$

When this network is stimulated with a sinusoidal signal with a frequency of f_{mod} the response will be

$$I ( t ) = \frac{1}{\sqrt{{( τ2π {f}_{mod} )}^{2} + 1}} sin ( 2 π {f}_{mod} t - {tan}^{- 1} ( τ2π {f}_{mod} ) )$$

If the in-phase and quadrature components of the response (as I and Q), are measured, it can be determined:

$$τ = \frac{1}{2 π {f}_{mod}} \frac{Q}{I}$$

For errors in I and Q that are small compared to their respective components, it can be determined:

$$\frac{Δτ}{τ} = \sqrt{{( \frac{Δ I}{I} )}^{2} + {( \frac{Δ Q}{Q} )}^{2}}$$

If there is a limited total photon budget and shot noise is limited, it can be beneficial to choose an operating point where I≈Q. Converting photon count and imposing Poisson statistics, it can be determined:

$$\frac{Δτ}{τ} = \sqrt{\frac{1}{{N}_{I}} + \frac{1}{{N}_{Q}}}$$

The in phase signal, for instance, is the difference of two photon-counting processes. When these differences are formed, the resulting variance is the sum of the two variances, but the usable signal is the difference. So, if it determined that that I=I_{A}−I_{B} (where A and B denote the two half-intervals that contribute to the full summation), then,

$${( \frac{Δ I}{I} )}^{2} = \frac{{N}_{IA} + {N}_{IB}}{{( {N}_{IA} - {N}_{IB} )}^{2}}$$

If the excitation signal is an elevated sinusoid that just touches zero at the minimum, then it will include the sum of a DC component that has a magnitude equal to the magnitude of the AC component. As the AC component changes frequency (modulation rate), the DC component of the output will continue to have the same unit value, but as the AC frequency increases, the AC response will diminish. In this regard, modulation rates that are too high can lead to an output signal that will be a nearly-constant stream of photons, and the shot noise of the large constant component can interfere without ability to discern the small modulation to be evaluated. Even if the drive signal is fully modulated, the response signal will only contain a weak modulation.

In order to evaluate the actual photon counts, we can begin by supposing that we have analog expressions for I and Q relative to the DC response. We can determine the two separate photon counts that will be used to determine N_{I}. They will be obtained by integrating a sine wave over a half cycle:

$${N}_{IA} = {N}_{DC} ( 1 + \frac{2}{π} I ) \\ {N}_{IB} = {N}_{DC} ( 1 - \frac{2}{π} I )$$

### So

$${( \frac{Δ I}{I} )}^{2} = \frac{2}{{{N}_{DC} ( \frac{4}{π} I )}^{2}} = \frac{{π}^{2}}{8 {N}_{DC} I}$$

If we operate with τ2πf_{mod}=1, then

$$I = Q = \frac{1}{\sqrt{2}} \\ \frac{Δτ}{τ} = \sqrt{{( \frac{Δ I}{I} )}^{2} + {( \frac{Δ Q}{Q} )}^{2}} = \frac{π}{2} \sqrt{\frac{\sqrt{2}}{{N}_{DC}}} = \frac{1.87}{\sqrt{{N}_{DC}}}$$

FIG. 5, for instance, illustrates one embodiment of the timing of a light source control signal used to provide excitation light and measurement of a photo-response at a pixel of the time-of-flight sensor according to example embodiments of the present disclosure.

Curve 110 represents the timing of an illumination control signal. As shown the illumination control signal has multiple cycles 112 where the light source is controlled to emit excitation light for a first half of the cycle 112 and not to emit excitation light or to emit reduced excitation light for a second half of the cycle 112. In this way, the light source can be controlled to modulate the excitation light according to a modulation rate.

In some embodiments, the signal for each pixel can be switched between two analog integrators during each cycle. This integration scheme can proceed until a global shutter is closed and a frame is read out via an analog to digital converter. This process can be performed in phase with the modulation of the excitation light source to determine an in-phase response. The process can be repeated (but phase shifted by 90° to obtain the quadrature response.

Curve 120 represents measurement by a pixel of an in phase component of the response phase of the fluorescent emission or phosphorescent emission according to example aspects of the present disclosure. As shown, a first response 122 is provided to a first integrator for a first half cycle. A second response 124 is provided to a second integrator for a second half cycle. This process is repeated for a plurality of cycles (e.g., hundreds of cycles, ten hundreds of cycles, thousands of cycles, millions of cycles) for a frame. The in-phase component of the response phase can be determined from the first response 122 and the second response 124. For instance, the in-phase component of the response phase can be determined by digitally subtracting the second response 124 from the first response 122.

Curve 130 represents measurement by a pixel of a quadrature component of the response phase of the fluorescent emission or phosphorescent emission according to example aspects of the present disclosure. As shown, the timing of switching between a first integrator and a second integrator is shifted by 90° relative to curve 120. A first response 132 is provided to a first integrator for a first half cycle. A second response 134 is provided to a second integrator for a second half cycle. This process is repeated for a plurality of cycles (e.g., hundreds of cycles, thousands of cycles) for a frame. The quadrature component of the response phase can be determined from the first response 132 and the second response 134. For instance, the quadrature component of the response phase can be determined by digitally subtracting the second response 124 from the first response 122.

As discussed above, the one or more processors can be configured to determine the fluorescent lifetime based at least in part on the response phase. More particularly, the one or more processors can be configured to determine the fluorescent lifetime based at least in part on the in phase component and the quadrature component of the response phase. In some embodiments, the fluorescent lifetime can be determined (e.g., by the one or more processors) based at least in part on the following:

$$τ = \frac{1}{2 π fmod} \frac{Q}{I}$$

In the system illustrated in FIG. 4A, the light source 12 and the time-of-flight sensor 14 are both positioned on the same side of the biological sample being tested. The configuration of FIG. 4A is similar to the configuration of the system illustrated in FIG. 4B. As shown in FIG. 4B, the light source 12 and time-of-flight sensor 14 are both positioned on the same side of microplate 11 that defines a plurality of sample staging sites 10. In FIG. 4B, the light source 12 and time-of-flight sensor 14 are integrated into a single component.

Referring to FIG. 4C, an alternative arrangement of a system in accordance with the present disclosure is shown. In FIG. 4C, the the light source 12 and the time-of-flight sensor 14 are positioned on opposite sides of the biological sample being tested. As shown in FIG. 4C, the light source 12 is positioned above the microplate 11 and sample staging sites 10, while the time-of-flight sensor 14 is positioned below the microplate 11 and the plurality of sample staging sites 10.

The systems and processes according to example aspects of the present disclosure are well suited to measuring any biological constituent that can produce a fluorescent emission or phosphorescent emission either alone or in combination with a fluorophore. In one aspect, for instance, the constituent can be contained in a biological sample, such as in cellular material. The constituent being tested can be a gas, a solid, a gel, or a liquid. The one or more constituents being measured can be measured from a living or viable sample or from a non-viable sample.

Constituents that can be measured from biological samples include all different types of metabolites. The method can include not only verifying the presence of the constituent but also determining a magnitude characteristic of the constituent or a parameter related to the constituent from the fluorescent lifetime or the fluorescent intensity. The constituent can be a lipid, an ion, a dissolved gas, a salt, a mineral, a nucleic acid, a protein, a polypeptide, or an enzyme. A parameter related to the constituent can be temperature, pH, an oxidation state, or a viscosity and the change the constituent causes to these parameters as a result of cellular metabolism. Dissolved gases that can be measured include oxygen, carbon dioxide, nitric oxide, or ammonia. The invention contemplates measuring the constituent and/or the parameter related to the constituent. In one embodiment, the constituent being measured oxygen consumption by the mitochondria of a cell and the parameter being measured is the by-product of oxygen consumption such carbon dioxide, lactate, and the like. In another embodiment, the constituent or parameter being measured may comprise an intrinsically fluorescent metabolic cofactor, such as nicotinamide adenine dinucleotide (NAD⁺/NADH), NAD(P)H, or flavin adenine dinucleotide (FAD/FADH₂). In one embodiment, nitrite reductase (NAD(P)H) can be monitored and analyzed. Nitrite reductase is an enzyme that catalyzes reactions related to nitrogen metabolism.

The constituent can be contained within the cell or can comprise a material secreted by the cells into the surrounding media. For example, any of the specific constituents or parameters described above can be monitored, analyzed or mapped in and around a cell's microenvironment. In one embodiment, the system can be used to measure changes in the constituent or parameter and provides rates of change in the particular parameter or constituent. In one embodiment, the microenvironment of a cell or cells can be monitored and modulated via external manipulation as a means of modelling in vivo conditions, such as hypoxia applications, TME modelling, Ischemia reperfusion, and the like.

The system of the present disclosure can provide information regarding a parameter or constituent in two dimensions or in three dimensions. For example, FIG. 15 is an illustration of three dimensional measurements. The three dimensional diagram 80, for instance, can represent a gas concentration or partial pressure, such as oxygen. The three dimensional diagram 82, on the other hand, can represent a pH or temperature. As shown the diagrams 80 and 82 can provide robust information regarding the parameter of interest, including information regarding the parameter at a particular location and/or at a particular point in time.

In one aspect, the systems and processes according to example embodiments of the present disclosure can be used to monitor the bioenergetics of live cells and in real time. For example, the systems and processes according to example aspects of the present disclosure can be used to monitor mitochondrial respiration and/or glycolysis of living cells . In some embodiments, the systems and processes may be used to monitor intracellular or microenvironmental pH, oxygen concentration, redox potential, or the like. These cellular functions typically revolve around the consumption of oxygen and the efflux of protons. In some embodiments, the systems and processes of the invention may be used to monitor other embodiments of metabolism or bioenergetics, such as redox potential, or relative concentrations of metabolites or cofactors such as NAD(P)H or FAD/FADH. The systems and processes according to example aspects of the present disclosure can be used to detect extracellular changes in these parameters in order to measure rates of cellular respiration, glycolysis, and ATP production.

The cells being tested can comprise any suitable cell sample, including but not limited to cultured cells, primary cells, human cells, neurons, T cells, B cells, epithelial cells, muscle cells, stem cells, induced pluripotent stem cells, immortalized cells, pathogen-infected cells, bacterial cells, fungal cells, plant cells, archaeal cells, mammalian cells, bird cells, insect cells, reptile cells, amphibian cells, and the like. The cells being tested may also comprise three-dimensional cell samples, such as tissue samples, cell spheroids, biopsied samples, cell scaffolds, organs-on-a-chip, and the like. Examples of parameters that may be measured and are related to the above cell functions include carbon dioxide concentration, oxygen concentration or oxygen partial pressure, calcium ions, hydrogen ions, and the like. Through these tests, one can gain an understanding of what drives cell phenotype and function and/or an accurate picture of the cellular environment or microenvironment. In one embodiment, background fluorescence from a tissue sample in accordance with the present disclosure can generate a map of a tissue section. Different structures of the cell can then be identified due to the different fluorescent characteristics of each structure. In this manner, different proteins, cell organs, and molecules can be mapped from the tissue section. Artificial stains can be generated.

The systems and processes according to example aspects of the present disclosure are particularly well suited to monitoring fluorophores with very short fluorescent lifetimes, including fluorophores indicative of pH including pH rate changes over time. Fluorophores related to pH, for instance, are known to have extremely short fluorescent lifetimes. Systems and processes according to example aspects of the present disclosure, however, can operate at modulation rates that can measure fluorescent lifetimes of less than about 500 nanoseconds, 100 nanoseconds, such as less than about 75 nanoseconds, such as less than about 50 nanoseconds, such as less than about 40 nanoseconds, such as less than about 30 nanoseconds, such as less than about 20 nanoseconds, such as less than about 15 nanoseconds, such as less than about 10 nanoseconds, such as less than about 8 nanoseconds, such as less than about 6 nanoseconds, such as less than about 4 nanoseconds, such as less than about 3 nanoseconds, such as less than about 2 nanoseconds, such as even less than about 1 nanosecond. In fact, it is believed that the systems and processes according to example aspects of the present disclosure of the present disclosure can detect fluorescent lifetimes as short as 0.1 nanoseconds or greater.

The systems and processes according to example aspects of the present disclosure can be used to measure live cell metabolic data, or (micro)environmental conditions of any viable cell. The cellular material being tested, for instance, can comprise bacteria cells, fungus cells, yeast cells, prokaryotic cells, eukaryotic cells, and the like. Cells that can be tested include mammalian cells including animal cells and human cells. Particular cells that can be tested include cancer cells, immune cells, immortal cells, primary cells, induced pluripotent stem cells, cells infected with viral or bacterial pathogens, and the like.

For example, in one aspect, the systems and processes according to example aspects of the present disclosure can be used to assist in immunotherapy. Immunotherapy is a type of treatment that bolsters a patient's immune system for fighting cancer, infections, and other diseases. Immunotherapy processes, for instance, can include the production of T cells and/or natural Natural Killer (NK) cells. During T cell therapy, for instance, T cells are removed from a patient's blood. The T cells are then sent to a bioreactor and expanded or cultivated. In addition, the T cells can be changed so that they have specific proteins called receptors. The receptors on the T cells are designed to recognize and target unwanted cells in the body, such as cancer cells. The modified T cells are cultivated in a bioreactor to achieve a certain cell density and then supplied to a patient's body for fighting cancer or other diseases. T cell therapy is typically referred to chimeric antigen receptor (CAR) T cell therapy. The use of T cells for CAR therapy has recently proliferated due to great success in combating blood diseases. In some embodiments, aspects of the present invention may be used to monitor the health of T cells used in (CAR) T cell therapy. In some embodiments, aspects of the present invention may be used to monitor T cell activation, T cell exhaustion, T cell metabolism, and the like.

NK cells are a type of cytotoxic lymphocyte that can seek out and destroy infected cells within the body. NK cells can display very fast immune reaction responses. Consequently, the use of NK cells in anticancer therapy has grown tremendously in interest and popularity. There is only a limited number of NK cells in the blood of a mammal, however, requiring that NK cells be grown to relatively high cell densities within bioreactors.

The culturing of cells, such as T cells, NK cells, or other mammalian cells, typically requires a somewhat complex process from inoculation to use in patients. The system and process of the present disclosure can be used to monitor cell metabolism during any point in the culturing process to ensure that the cells are healthy, and/or have the desired metabolic phenotype, and that the media in which the cells are growing contains an optimized level of nutrients. The system and process, for instance, can be used to make adjustments for assuring the metabolic fitness of the cells as they are growing.

In addition to immune cells, the metabolism of cancer cells can also be monitored for providing an understanding of which nutrients fuel the cancer cells. For example, the systems and processes according to example aspects of the present disclosure can reveal mechanisms or components that impact the metabolism of the cancer cells for inhibiting growth. The systems and processes according to example aspects of the present disclosure can also be used to determine the speed at which the cancer cells may proliferate. The system and process of the present disclosure is also well suited for use in toxicology. For instance, the process and system of the present disclosure can be used to detect mitochondrial liabilities among potential therapeutics. The risk of mitochondrial toxicity, for instance, can be assessed with high specificity and sensitivity. In this manner, the mechanism of action of some mitochondrial toxicants can be determined.

The systems and processes according to example aspects of the present disclosure can also be used to assist in treating obesity, diabetes, and metabolic disorders. For instance, the process and system can be used to measure functional effects of genetic changes to metabolic pathway components. Nutrients used in healthy and diseased cell models can be examined. Further, fatty acid oxidation and glycolysis can be assessed in different cell types.

When measuring cellular parameters related to cellular material, the constituent of interest can be contained within the cell or can be measured from a medium surrounding the cell. For instance, the cell parameter or constituent can be secreted by the cell into the surrounding medium and measured. The sample staging site can be configured to have compatibility with both adherent and suspension cells as well as isolated mitochondria.

When testing for and measuring a fluorophore in accordance with the example aspects of the present disclosure, single measurements can be taken under some circumstances. The systems and processes of the present disclosure, however, is well suited to taking multiple measurements very rapidly to permit multiple determinations of fluorescent lifetime or fluorescent intensity of a fluorophore related to a biological parameter. For example, the fast cycle times in conjunction with significant multiplexing capabilities allows for conducting multiple measurements of the fluorophore very quickly. For instance, the fluorescent lifetime or fluorescent intensity of a fluorophore related to a cellular parameter, can be determined multiple times in less than about 60 seconds, such as less than about 30 seconds, such as less than about 10 seconds, such as less than about 5 seconds, such as less than about 1 second, such as even less than about 0.5 seconds. In the above periods of time, the fluorophore can be measured greater than 10 times, such as greater than 100 times, such as greater than 200 times. The multiple measurements can be used to determine rates of change and/or can be averaged for improving accuracy.

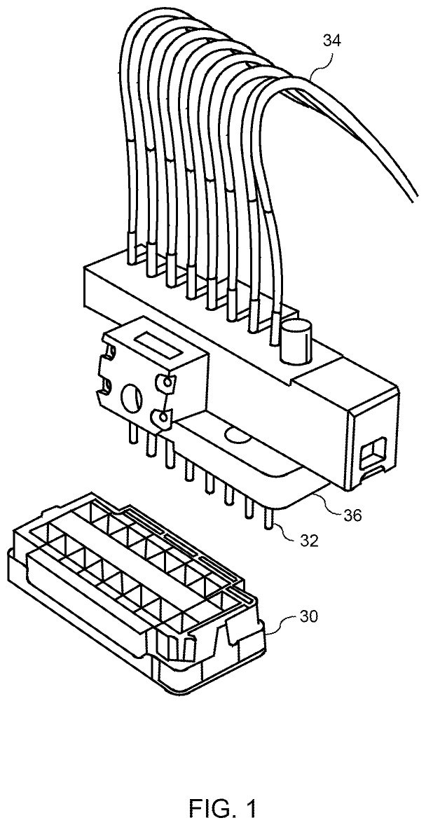

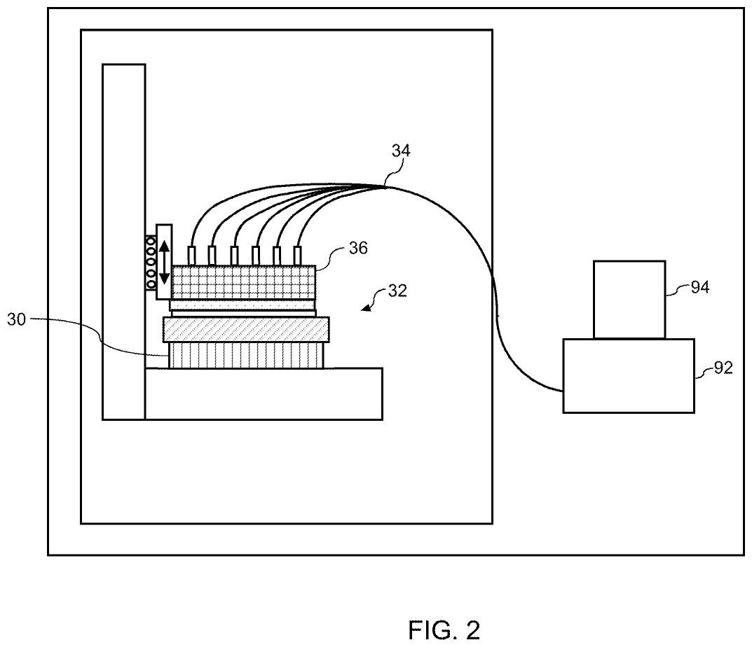

The system as shown in FIG. 4A, 4B or 4C can be incorporated into numerous and diverse instruments for measuring for the presence of constituents and/or for the presence of constituent or parameter concentrations. Referring to FIGS. 1-2 and 6-8, one embodiment of a system incorporating the components illustrated in FIG. 4A is shown. The system illustrated in FIGS. 1-2 and 6-8 is particularly well suited for conducting multiple assays simultaneously of biological samples, such as cellular material. The system illustrated in FIGS. 1 and 2, for instance, can be used to test multiple biological samples simultaneously and test for one or more constituents or cell parameters in each sample simultaneously.

For illustrative purposes only, the invention in FIGS. 1 and 2 is demonstrated in an instrument configuration well suited to monitoring metabolic processes of live cells. The embodiment of FIGS. 1 and 2 is intended in no way to limit the scope of the present disclosure. The optical detection system of the present disclosure can be incorporated into any suitable biological sensor or imaging system. As shown in FIGS. 1 and 2, the system includes a microplate 30 that defines a plurality of sample staging sites for receiving biological samples. The microplate 30 is designed to be placed in association with a plurality of plungers or probes 32 that are configured to move towards and away from a microplate 30 loaded into the apparatus. Each plunger 32 is in communication with a light pipe 34. The light pipe 34 can be a single fiber optic or a bundle of fiber optics as shown. The light pipe 34 is for delivering light to biological samples contained in the microplate 30 and for communicating fluorescent emissions or phosphorescent emissions to a time-of-flight sensor.

As shown in FIGS. 1 and 2, the system can include a mounting block 36 which can hold the plungers 32. The mounting block can be in operative association with a motor for causing the mounting block 36 to reciprocate back and forth. Alternatively, the microplate 30 can be placed on a platform that lifts the microplate into contact with the plungers 32.

The light pipes 34 can be placed in communication with a light source and a time-of-flight sensor. The time-of-flight sensor and/or light source can also be placed in communication with one or more processors 92 (FIG. 2). The one or more processors 92 can obtain and process measurements from the time-of-flight sensor according to any of the systems and processes described herein. The one or more processors 92 can provide the information to a user via a display device 94 or other suitable user interface(s) (e.g., audio, visual, and/or interactive interface).

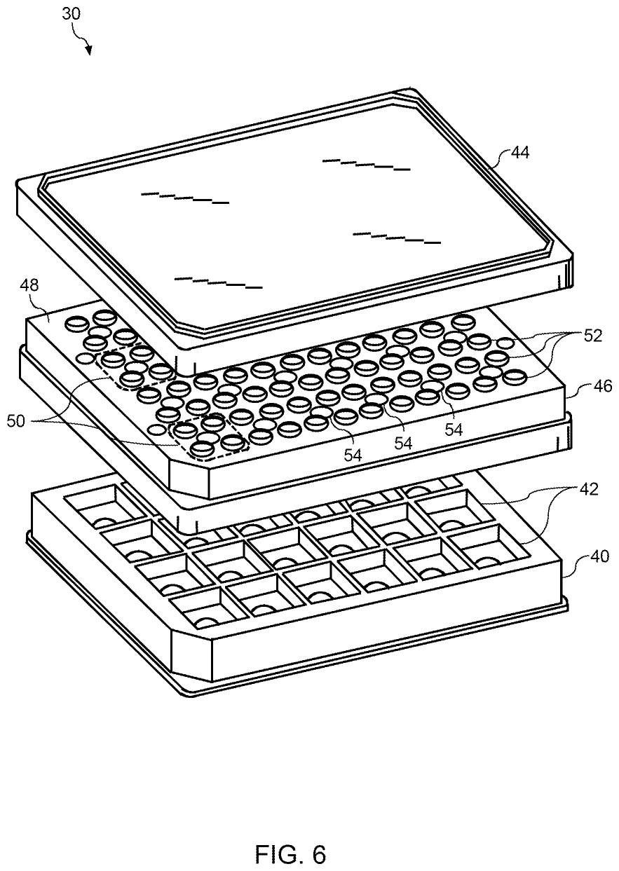

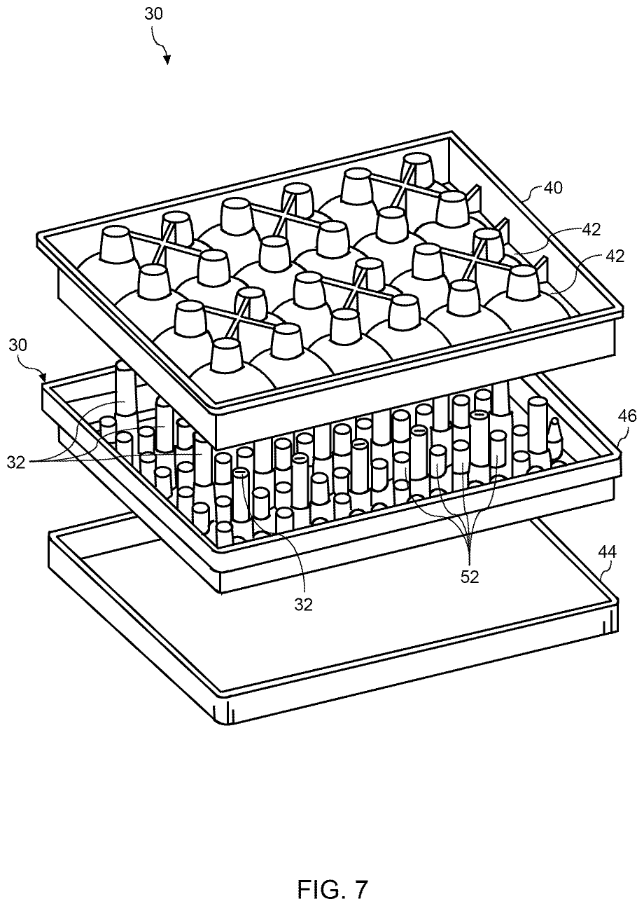

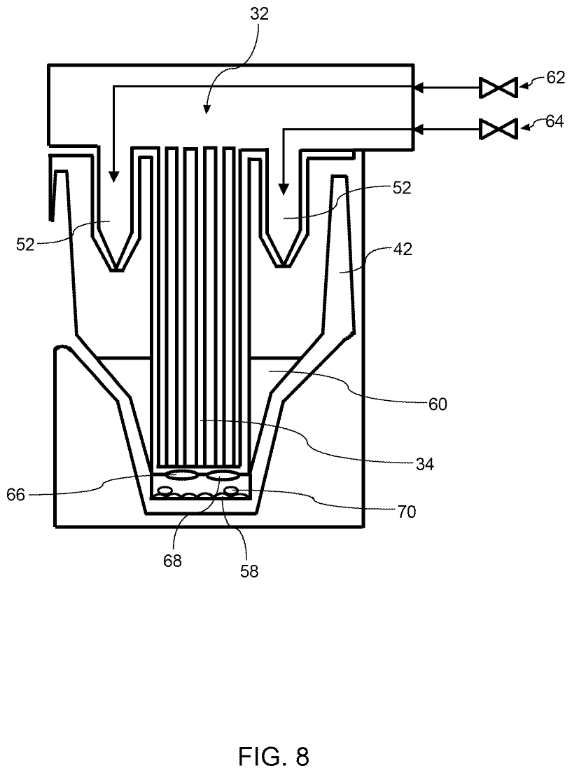

Referring to FIGS. 6 and 7, one embodiment of a microplate 30 that can be used to hold biological samples, deliver one or more fluids to the samples, and assist in placing the samples in communication with the plungers 32 is shown. The microplate 30 can include a well plate 40 that defines a plurality of sample staging sites 42. The well plate 40 can be combined with a removable cover 44. Although the well plate 40 illustrated in FIG. 6 is shown containing 24 sample staging sites 42, it should be understood, as described above, that the well plate 40 can contain many more or less sample staging sites 42. In fact, the number of sample staging sites 42 can vary from one to several thousand or more. In some embodiments, a single sample staging site of nearly any size can be fabricated or multiple sample staging sites may be fabricated in a one-dimensional or two-dimensional arrangement.

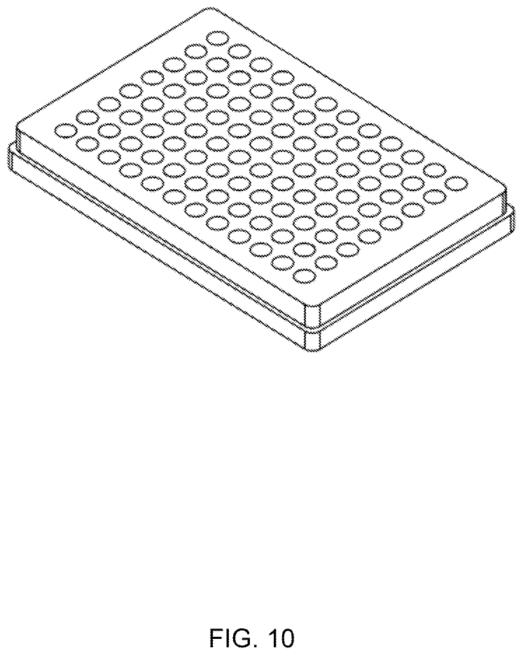

For example, an alternative embodiment of a microplate 30 is shown in FIG. 10. The microplate 30 illustrated in FIG. 10 includes 96 separate sample staging sites 42. The microplate 30 shown in FIG. 10 can easily be incorporated into the system of the present disclosure illustrated in FIGS. 1 and 2.

Referring back to FIGS. 6 and 7, the microplate 30 is generally a planar element comprising a frame 46. The different elements of the microplate 30 can be made from any suitable material, such as molded plastics or from a modular glass fixture. The frame 46 can include a surface 48 that defines a plurality of regions 50. The plurality of regions 50 can correspond with the number and location of the plungers illustrated in FIGS. 1 and 2. Likewise, the number and location of the plurality of regions 50 also correspond with the number and locations of the sample staging sites 42. In the embodiment illustrated in FIG. 6, each region 50 includes first, second, third, and fourth ports 52. The ports 52, as will be described in greater detail below, facilitate delivery of gases and/or reagents to the sample staging sites 42. Each region 50 also includes a central aperture 54 for receiving a corresponding plunger 32. The ports 52 are sized and positioned so that groups of four ports may be positioned over a single sample staging site 42. A gas or liquid from the four ports may be delivered to a respective sample staging site 42. In other embodiments, the number of ports in each region can be less than four or greater than four. The central aperture 54 and each corresponding plunger 32 may be compliantly mounted relative to the well plate 40 so as to permit it to nest within the well plate by accommodating lateral movement.

Each of the ports 52 may have a cylindrical, conical or cubic shape that defines an opening through the surface 48 of the frame 46. Each port 52 can also be closed at the bottom facing the sample staging site 42 except for a small hole, such as a capillary aperture. The aperture or hole can be centered along the bottom surface. The capillary aperture is adapted to retain test fluid in the port 52 such as by surface tension, absent an external force, such as a positive pressure differential force, a negative pressure differential force, or possibly a centrifugal force. Each port 52 may be fabricated from a polymer material that is impervious to gases, test fluids, or from any other solid material. The liquid volume of each port 52 can vary. In one aspect, for instance, the liquid volume of each port 52 can range 200 microliters to about 500 microliters, although volumes outside this range are contemplated.

Referring to FIG. 7, the microplate 30 is shown in an inverted configuration. In addition, plungers 32 are shown extending through the central apertures of the frame 46. The plungers 32 are adapted to be inserted into each of the sample staging sites 42 for coming into proximity with the biological sample being tested.

The removable cover 44 is also illustrated in FIG. 7. The cover 44 can be used to help prevent evaporation or contamination of a sample or of a media disposed in the microplate.

Referring to FIG. 8, a cross-sectional view of a single sample staging site 42 is shown. The sample staging site 42 contains a biological sample 58 contained in a media 60. The biological sample 58 contains one or more constituents or cellular parameters to be tested. In FIG. 8, a probe or plunger 32 is shown in association with the sample staging site 42 such that the plunger 32 is in contact with or close proximity to the biological sample 58. As described above, the plunger 32 is designed to reciprocate between a testing position as shown in FIG. 8 and a non-engagement position where the plunger is withdrawn from the sample staging site 42.

Two ports 52 are also illustrated that are designed to deliver fluids, such as liquids and gases, to the sample staging site 42. For example, in one embodiment, the ports 52 can be in communication with an external gas supply 62 and an internal air control 64. The external gas supply 62 and the internal air control 64 can control gases fed to or removed from the head space above the media 60. The internal air control 64 may be ambient air from inside the instrument that is compressed via a small internal compressor to pressurize the ports 52 to deliver fluids, such as drug compounds. The delivery of gas to the head space may allow manipulation of the environment around the test sample to create conditions simulating hypoxia, anoxia, or normoxia and/or low pH. In some embodiments, a biologically inert gas such as nitrogen may be injected into the media 60 in the sample staging site 42 above the surface of the media 60 for controlling the composition of gas in the head space or in the media. The gas can be used to flush the headspace if desired.

As described above, for instance, each sample staging site 42 may be in combination with four ports 52. The ports 52 can be used to deliver various compounds to the biological sample 58 within the sample staging site 42. For example, a common test performed on the instrument is a mitochondrial stress test. In this assay, a series of injections are delivered through the drug ports of the microplate in order to measure the response of the biological sample to various compounds (oligomycin, FCCP, rotenone and antimycin). These compounds are preloaded into a drug reservoir (port) on the microplate prior to execution of the assay. When the microplate is inserted into the instrument it is coupled to a manifold which when activated by a solenoid valve, provides pneumatic pressure to the head space of the reservoir forcing the compound through a small orifice and into the sample staging site 42 containing the biological sample. The pneumatic manifold and valve system may be modified to redirect one of these ports to an external gas supply (gas cylinder or bottle). The gas supply may be connected to the instrument through a port on the rear connector panel. The bottle may be located near the instrument and may contain a regulator and bubbler for humidification of the incoming gas. When activated, a solenoid valve may open, allowing the gas to flow through the manifold/microplate interface, through the drug port orifice, and into the head space above the biological sample. By oscillating the plunger (probe) vertically, the gas will be mixed with the medium allowing control of the available oxygen to the sample. For example, by perfusing nitrogen into the head space, the available O₂ in the medium is displaced and a more hypoxic condition is created around the sample. By turning off the gas and mixing, ambient levels of O₂ may be re-established.

In some embodiments, a source of a solution of a biologically active substance may be in fluid communication with media in sample staging site 42 for exposing a sample to the substance.

The number of ports 52 associated with each sample staging site 42 determines the number of components that can be added to the sample staging site 42 during testing. In some embodiments, no fluids are required for testing to occur. In other embodiments, such as when conducting a mitochondrial stress test as described above, a plurality of different components may be fed to the sample staging site for affecting the conditions surrounding the biological sample 58. By having multiple ports 52, the system and process can also permit the testing of multiple conditions per each single staging site 42. In addition to a mitochondrial stress test, other tests that may be operated using the system illustrated in FIGS. 1-2 and 6-8 are a ATP rate assay test that measures the rates of ATP production from glycolysis and mitochondrial respirations simultaneously, a glycolytic assay test that measures glycolysis in live cells revealing transient responses and rapid metabolic switches not discernible in other assays, a substrate oxidation test that measures cellular substrate oxidation by assessing changes in oxygen consumption in live cells, and a cell energy phenotype test that measures mitochondrial respiration and glycolysis.

As shown in FIG. 8, the plunger or probe 32 includes a plurality of fiber optics 34 that deliver excitation light to the biological sample 58 and transmit fluorescent emissions or phosphorescent emissions to the time-of-flight sensor for measuring fluorescent lifetimes and/or fluorescent intensity. In certain applications, the constituent being tested in the biological sample 58 can be auto-fluorescent or wherein a fluorophore is endogenous to the biological sample 58 for causing the constituent to undergo a fluorescent emission or phosphorescent emission when contacted with excitation light. The system of the present disclosure is also well suited to producing images using FLIM. The image can be used to take measurements of various parameters including NAD(P)H.

Alternatively, the system can deliver one or more fluorescent emission or phosphorescent emission agents, such as fluorophores, to the biological sample 58 that are influenced by the presence of a biological constituent when undergoing a fluorescent emission or phosphorescent emission. For example, as shown in FIG. 8, the plunger 32 can include a pair of fluorophore sensors 66 and 68. The fluorophore sensors 66 and 68 can be the same or can be different for measuring different constituents or the same constituent under different conditions.

The fluorophore sensors 66 and 68 can contain any suitable fluorophore or fluorescent agent that facilitates a fluorescent emission or phosphorescent emission. In general, fluorophores absorb light energy of a specific wavelength and re-emit the light at a different wavelength, such as a longer wavelength. The absorbed wavelengths, energy transfer efficiency, and time before emission depend on both the fluorophore structure and its chemical environment.

When the constituent being measured is oxygen concentration or oxygen partial pressure, a fluorophore can be used with the signal inversely proportional to oxygen concentration such as a porphyrin, ruthenium, or rhodamine compound immobilized as a particle or homogeneously distributed in an oxygen permeable polymer, such as silicone rubber or polyurethane hydrogel. When measuring pH, a fluorescent indicator dye can be incorporated into the fluorophore sensor. One such dye is fluorescein, whose signal decreases upon protonation of the dye and which is either in, on, or entrapped in a particle that is suspended in a carrier polymer or covalently attached to a hydrophilic polymer.

A list of possible fluorophores indicative of pH include, but are not limited to the following in Table 1:

TABLE 1
Example fluorophores used to measure pH

| | | | τ(O₂) | τ(O₂) | τ | τ |
|---|---|---|---|---|---|---|
| | | | (ns) | (ns) | (ns) | (ns) |
| | λₑₓ | λₑₘ | pH | | | |
| | (nm) | (nm) | low | high | low | high |
| Fluorescein | 460 | 550 | 3.6 | 4.2 | 3.6 | 4.2 |
| Fluorescein Na salt | 460 | 550 | 3.6 | 4.2 | 3.6 | 4.3 |
| Fluorescein diacetate | 460 | 550 | 3.5 | 4.0 | 3.5 | 4.0 |
| Fluoresceinamine Isomer 1 | 460 | 550 | 3.3 | 3.9 | 3.3 | 3.9 |
| Fluoresceinamine Isomer 2 | 460 | 550 | 3.0 | 3.9 | 3.0 | 4.0 |
| FITC | 460 | 550 | 3.4 | 4.1 | 3.4 | 4.1 |
| 6-Carboxyfluorescein | 460 | 550 | 3.5 | 4.0 | 3.5 | 4.0 |
| BCECF | 460 | 550 | 3.0 | 3.8 | 3.0 | 3.8 |
| SNAFL calcein | 460 | 550 | 3.4 | 2.7 | 3.4 | 2.7 |
| HPTS | 410 | 500 | 5.4 | 5.4 | 5.4 | 5.4 |
| 10-(3-Sulfonyl) acridinium | 380 | 500 | 31.2 | 30.6 | 31.2 | 30.7 |
| betaine | | | | | | |
| Acridine Orange | 460 | 550 | 1.9 | 2.0 | 1.9 | 2.0 |
| Rhodamine B | 410 | 600 | 1.8 | 1.7 | 1.8 | 1.8 |
| Acridine | 380 | 450 | 26.3 | 13.7 | 26.3 | 14.0 |
| Acridine | 380 | 500 | 31.1 | 22.1 | 31.2 | 22.4 |

The above provides fluorescent lifetimes of dyes at a pH of between 5.2 and 7.9 in phosphate buffered solutions. The data is for oxygenated solutions and deoxygenated solutions.

When measuring carbon dioxide, a sensor that is based on a pH sensitive transducer can be used. The fluorescence can be indirectly modulated by the production of carbonic acid due to reaction of carbon dioxide with water.

A fluorophore that detects glucose also can be used, such as one based on a non-enzymatic transduction using a boronic probe that complexes with glucose, resulting in a charge transfer that modulates the fluorescence of the probe, or an enzymatic glucose transducer that couples a glucose oxidase to a fluorescent oxygen sensor, with the binding and oxidation of glucose resulting in a quantitative modulation of the oxygen sensor. It also is within the scope of embodiments of the disclosure to employ a fluorophore or other type of sensor sensitive to biological molecules such as, for example, lactate, ammonia, or urea. A lactate sensor can be based on an enzymatic sensor configuration, with lactate oxidase coupled to a fluorescent oxygen sensor, and with the binding and oxidation of lactate resulting in a quantitative modulation of the oxygen sensor. An ammonia or ammonium ion sensor can be configured with immobilization of a protonated pH indicator in a hydrophobic, gas permeable polymer, with the fluorescence output quantitatively modulated by reaction with transient ammonia. A urea sensor can be based on an enzymatic sensor configuration, with urease coupled to a fluorescent ammonia transducer, and with the binding and reduction of urea to ammonia, resulting in modulation of the ammonia sensor fluorescence. The nature of the sensor generally does not form an aspect of embodiments of this invention.

As shown in FIG. 8, the fluorophore source can be located on the plunger or probe that is placed in communication with the biological material. Alternatively, the fluorophore source can be located in the biological material sample. The biological material may comprise cells and the fluorophore may be located within the cells, on the cell, or may be located in a microenvironment surrounding the cells. In one embodiment, the fluorophore may be encapsulated in nanoparticles or microparticles that are coupled to the plunger or probe, are in a suspension surrounding the cells, or are in a solution surrounding the cells.

In one aspect, the fluorophore sensor can also include a quenching agent. The quenching agent can facilitate measurements by impacting the fluorescent signal. In one aspect, for instance, an oxygen-quenched fluorophore sensor is used.

As shown in FIG. 8, the plunger 32 is designed to lower into the sample staging site 42 for being placed in association with the biological sample 58. In one aspect, the plunger 32 can be lowered so as to form a microchamber 70. Creation of a microchamber allows rapid, real-time measurement of a constituent or parameter that is changing. Formation of the microchamber, for instance, allows for measurements of changing oxygen and proton concentrations in an extracellular medium. More particularly, the microchamber 70 enables the temporary creation of a highly concentrated volume of biological sample 58 or cells within a larger volume of cell media. This permits the sensitive measurements of change in constituents of the media that results from the biological activity of the cells.

In one embodiment, if desired, the plunger 32 can also provide perfusion by creating hydrostatic pressure in the column of medium above the biological sample 58. For instance, the plunger 32 can reciprocate vertically through the sample staging site 42 causing media to flow across and sometimes through the biological sample 58. By moving the plunger 32 up and down, media is moved across the biological sample 58, replenishing nutrients, providing oxygen, and sweeping away waste. Accordingly, the microenvironment around the biological sample 58 may be continuously perfused between measurements. As the plunger 32 moves into the bottom portion of the sample staging site 42, motion is stopped, a small transient volume is created, and measurements are made. Efficiency of perfusion through the sample staging site 42 may be increased by altering the stroke height, speed and clearances between the plunger 32 and the bottom of the sample staging site 42.

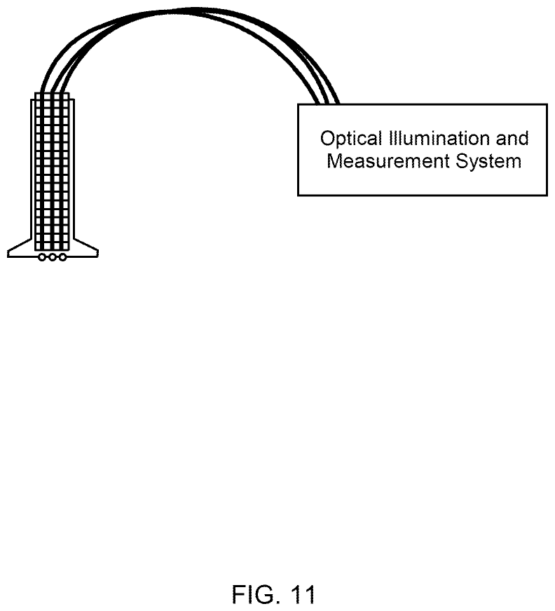

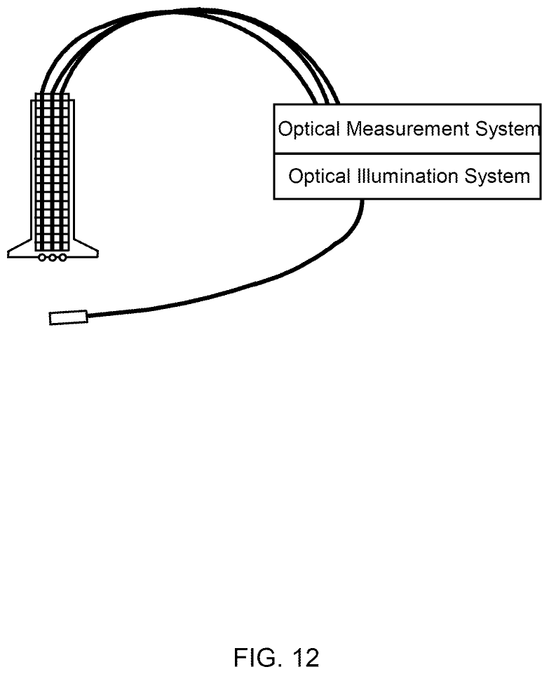

Referring to FIGS. 11 and 12, further embodiments of probes 32 that may be used in accordance with the present disclosure are shown. Like reference numerals have been used to represent the same or similar elements. As shown in FIG. 11, the probe 32 includes a bundle of fiber optics 74 that extend through the probe 32. The probe 32 includes fluorophore sensors 66 for being placed in association with a biological material being tested. In the embodiment illustrated in FIG. 11, the probe 30 further includes a barrier portion 72 that is designed to form a microchamber in a sample staging site for facilitating the taking of measurements.

As shown in FIG. 11, the optical illumination and measurement system, which includes a light source and a time-of-flight sensor, are both located on the same side of the sample staging site that would be placed below the probe 32 similar to the embodiment illustrated in FIG. 4B.

The probe 32 illustrated in FIG. 12 is similar to the probe illustrated in FIG. 11. As shown in FIG. 12, the probe 32 includes an optical fiber 74, a barrier portion 72, and fluorophore sensors 66. In the embodiment illustrated in FIG. 12, however, a light source 78 is placed below the probe 32. In this manner, the light source 78 is positioned below a sample being tested while the probe 32 is positioned above the sample. This is similar to the embodiment illustrated in FIG. 4C only the positions of the light source and the probe have been reversed.

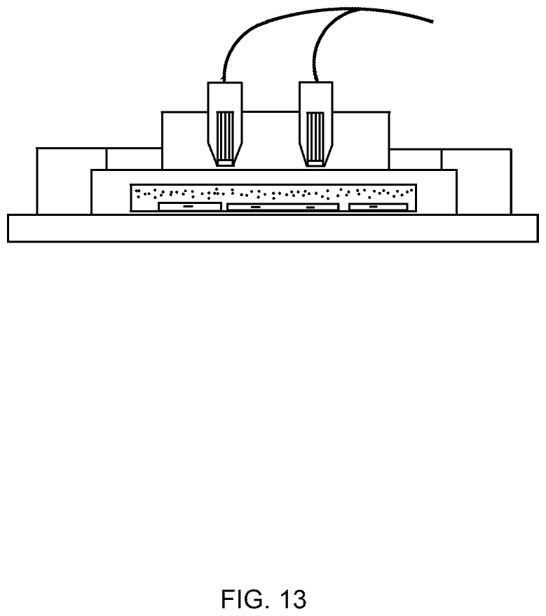

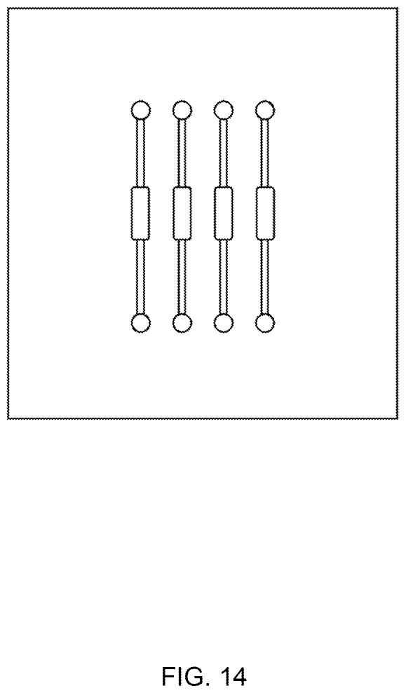

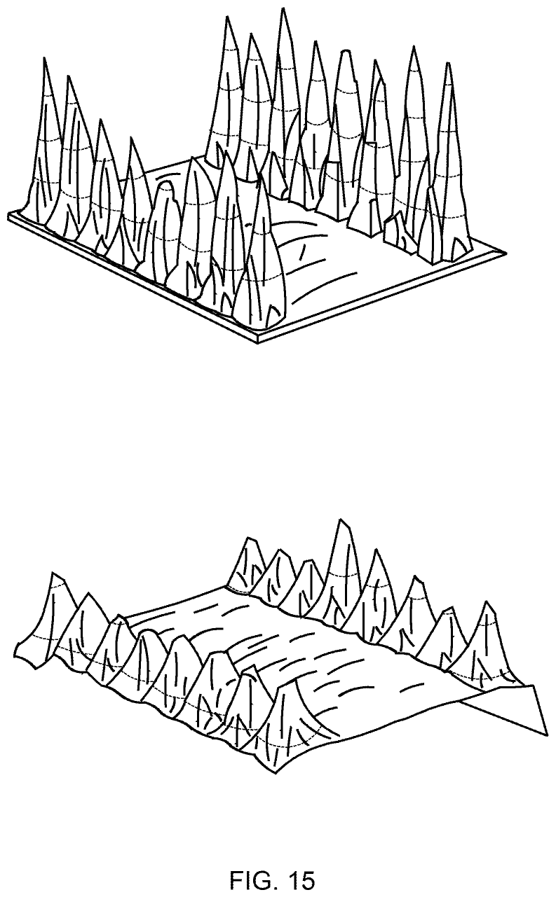

As described above, the optical system of the present disclosure can be incorporated into all different types of biological measurement and imaging systems. Referring to FIGS. 13 and 14, for instance, a microfluidic system 100 is shown that can be equipped with a light source and time-of-flight sensor in accordance with the present disclosure. The microfluidic system 100 includes a media channel 106 that is designed to circulate media on and around biological material 158. The media channel 106 is in communication with a media inlet 102 and a media outlet 104 for circulating a media as particularly shown in FIG. 14. For example, a cell media can flow through the channel 106 for saturating the biological samples 158, which can comprise living cells. The flow rate can be relatively low, such as from 1 micoliter per minute to 100 microliters per minute, such as from 2 micoliters per minute to 20 microliters per minute, such as from 5 micoliters per minute to 15 microliters per minute. The flowing media can ensure that the biological material 158 has a sufficient supply of oxygen, nutrients, and the like. In this manner, the microfluidic system 100 operates in a perfusion mode. The system illustrated in FIGS. 13 and 14 is particularly well suited to monitoring respiration and acidification rates.

As shown, the microfluidic system 100 further includes probes 132 in accordance with the present disclosure that are designed to monitor a biological constituent or parameter associated with the biological material 158. The probes 132 can be made similar to the probes 32 as illustrated in FIG. 8, 11, or 12. The probes 132 are in communication with a light pipe or fiber optics 134 for connecting the probes 130 to a light source and/or a time-of-flight sensor in accordance with the present disclosure.

In one embodiment, one of the probes 132 is for monitoring and measuring pH while the other probe 132 is for monitoring and measuring oxygen concentration. In this regard, the biological material 158 can be placed in communication with suitable fluorophores in order to measure fluorescent intensity or fluorescent lifetime.

Referring to FIG. 14, a plurality of microfluidic systems 100 are shown grouped together and mounted on a frame (such as a chip) 110. As illustrated, each microfluidic system 100 includes an inlet 102 and an outlet 104 for circulating media or fluid. In accordance with the present disclosure, the multiple microfluidic systems 100 can be in communication with a single or a plurality of light sources and/or time-of-flight sensors for monitoring cellular parameters in accordance with the present disclosure.

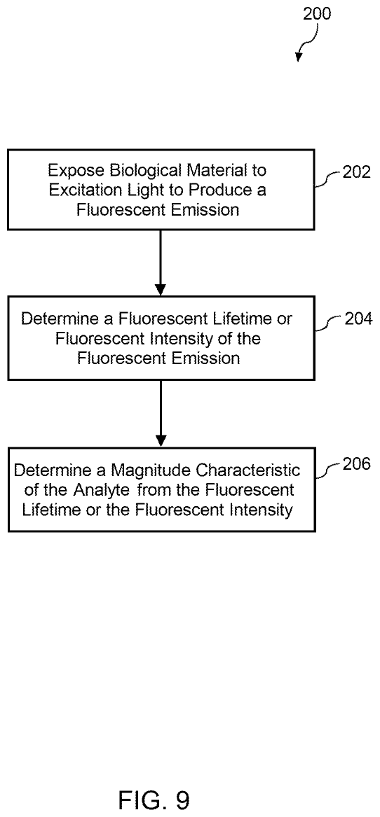

FIG. 9 depicts a flow diagram of an example process 200 according to example embodiments of the present disclosure. The process 200 can be implemented, at least in part, using any of the systems described herein. FIG. 9 depicts steps of the process 200 performed in a particular order for purposes of illustration and discuss. Those of ordinary skill in the art, using the disclosures provided herein, will understand that various steps of any of the processes provided herein can be adapted, rearranged, omitted, includes steps not illustrated, expanded, and/or modified in various ways without deviating from the scope of the present disclosure.

At 202, the process includes exposing biological material to excitation light in a manner that causes a constituent alone or in combination with a fluorophore to produce a fluorescent emission or phosphorescent emission. For instance, the process can include exposing biological material to excitation light that is modulates according to a modulation rate. The modulation rate can be for example, the modulation rate can be from about 0.5 MHz to about 1,000 MHz, such as from about 25 MHz to about 200 MHz.

At 204, the process includes determining a fluorescent lifetime or fluorescence intensity of the fluorescent emission or phosphorescent emission. For instance, in some embodiments, the signal for each pixel can be switched between two analog integrators during each cycle. This integration scheme can proceed until a global shutter is closed and a frame is read out via an analog to digital converter. This process can be performed in phase with the modulation of the excitation light source to determine an in-phase response. The process can be repeated (but phase shifted by 90° to obtain the quadrature response.

The fluorescent lifetime can be determined based at least in part on the in phase component and the quadrature component of the response phase. In some embodiments, the fluorescent lifetime can be determined (e.g., by the one or more processors) based at least in part on the following:

$$τ = \frac{1}{2 π fmod} \frac{Q}{I}$$

At 206, the process includes determining a magnitude characteristic of the constituent from the fluorescent lifetime or the fluorescent intensity. For instance, one or more processors can access a model (e.g., a machine learned model), lookup table, algorithm, correlation, etc., that correlates fluorescent lifetime or fluorescent intensity to the magnitude characteristic of the constituent.

The present disclosure may be better understood with respect to the following example.

### EXAMPLE

Measurements were performed using a time-of-flight sensor module to quantify fluorescent lifetimes with magnitudes of a few nanoseconds. The light detection and ranging system made use of a Sony IMX556 time-of-flight imaging chip installed in a Melexis EVK75027 evaluation module. This imaging sensor has 300,000 pixels on a ten-micron pitch. In keeping with a goal of providing a high level of multiplexing, measurements were performed with signals obtained from 250 of the available pixels. Accordingly, the resulting measurement performance can be considered as a projection of a performance that could be obtained with more than a hundred optical fibers simultaneously delivering fluorescent emission or phosphorescent emission signals to a single imaging chip.

The fluorophore used was a preparation of octaethylporphyrinketone (OEPK) in a PVC matrix spotted onto a mylar film. When exposed to buffer solutions with pH values from 4 to 8.5, this system provides a lifetime response that varies from roughly 3 nanoseconds to almost 6 nanoseconds. The excitation was provided by a Thorlabs L405P150 laser diode (with emission at 405 nm). The laser was operated with a bias current well below its design limit, resulting in emitted optical power of roughly 50 milliwatts. Before reaching the sensor spot, the beam was attenuated using a neutral density filter by a factor of 50 resulting in delivered optical power of less than 1 milliwatt. The emission was filtered with a bandpass filter centered at 647 nm with a full width half-maximum of 10 nm. The illumination path included a 45-degree dichroic long pass mirror with a cut-on wavelength of 490 nm.

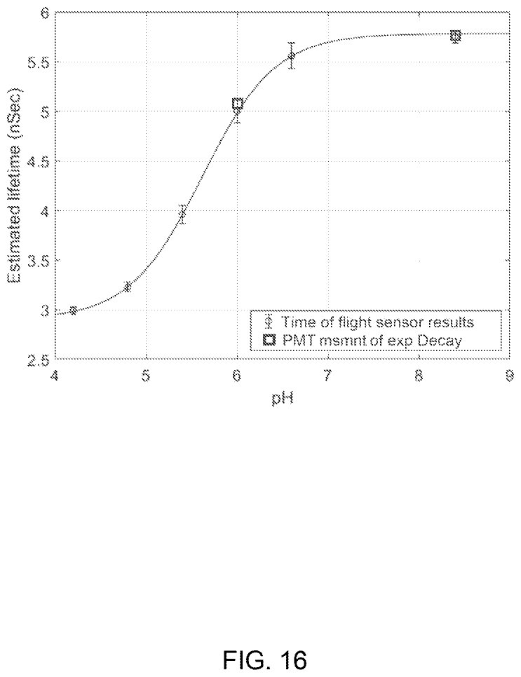

FIG. 16 displays the measured results with error bars that are ten times the standard deviation that was obtained for more than ten repeated measurements. In all cases, the standard deviation values were 0.01 nanoseconds or less. In the central region, the slope of the response curve is 1.7 nanoseconds per unit of pH, so the implied sensitivity to pH in that region is 6 milli-pH. The total integration time for individual measurements was not more than 20 milliseconds.

The plot shown in FIG. 16 includes two data points that were obtained by using a conventional photomultiplier tube (PMT) and a least squares fit to the time domain decay curve. The PMT is only capable of an individual measurement instead of 100 concurrent ones.

For some applications, noting changes in this apparent lifetime provides information about changing pH demonstrating the use of LiDAR in fluorescence lifetime measurements. Additional accuracy can be obtained by treating he light detection and ranging signal as if it were obtained by a sinusoidal demodulation of the optical signal. In this case, the phase can be estimated by using trigonometric functions. Typically, the demodulation process closely approximates a square wave, so a trig function analysis may result in erratic values that depend on the total (arbitrary) phase delay in the system. A sinusoidal demodulation provides immunity from the harmonic content of the modulation itself, but with square wave demodulation the system may be susceptible to the non-ideality of the modulation.

As an improvement to the above, two separate measurements were made with the phase of the excitation shifted for one measurement relative to the other, such as by 45 degrees. Then, if the final phase shift is evaluated as the average of the two measurements, the most severe degradation due to the non-sinusoidal demodulation can be eliminated. This is a two-step process, provides greater accuracy and was used to obtain the data in the plot shown in FIG. 16. A three-step procedure may result in a yet closer approximation to a desired sinusoidal demodulation system. Neither version will significantly impact the integration time requirement since the combined signal to noise ratio will be an improvement over the individual contributions.

These and other modifications and variations to the present disclosure may be practiced by those of ordinary skill in the art, without departing from the spirit and scope of the present invention, which is more particularly set forth in the appended claims. In addition, it should be understood that aspects of the various embodiments may be interchanged both in whole or in part. Furthermore, those of ordinary skill in the art will appreciate that the foregoing description is by way of example only and is not intended to limit the invention so further described in such appended claims.

1.-67. (canceled)

68. A system for analyzing biological material comprising:
a light source configured to emit excitation light onto a biological material sample, the excitation light having a wavelength that causes a fluorophore in proximity to or within the biological material to undergo a fluorescent emission or phosphorescent emission;
an optical communication path positioned to obtain an optical signal indicative of the fluorescent emission or phosphorescent emission associated with the fluorophore;
a time-of-flight sensor comprising a plurality of pixels configured to receive the signal indicative of the fluorescent emission or phosphorescent emission from the optical communication path, each pixel of the plurality of pixels configured to provide a signal associated with a photo-response of the pixel based at least in part on the optical signal; and
one or more processors in communication with the time-of-flight sensor, the one or more processors configured to determine a fluorescent lifetime or a fluorescent intensity of the fluorophore based at least in part on the photo-response of each pixel.

69. A system as defined in claim 68, further comprising a sample staging site for holding a sample of a biological material.

70. A system as defined in claim 68, wherein the light source and time-of-flight sensor are part of a Light Detection and Ranging (LiDAR) subsystem, and wherein the one or more processors are configured to determine the fluorescent lifetime or the fluorescent intensity of the fluorophore based on the fluorescent emission or phosphorescent emission of the fluorophore.

71. A system as defined in claim 68, wherein the one or more processors are further configured to determine a magnitude characteristic of a biological parameter based on the fluorescent lifetime or the fluorescent intensity.

72. A system as defined in claim 68, wherein the system includes a plurality of samples, each sample being associated with an optical communication path, wherein the pixels of the time-of-flight sensor are divided into a plurality of zones, each optical communication path associated with each sample being in communication with at least one of the plurality of zones, and wherein the time-of-flight sensor and the one or more processors are configured to receive fluorescent emissions or phosphorescent emissions from each sample and determine the fluorescent lifetime or the fluorescent intensity of a fluorophore from each sample.

73. A system as defined in claim 72, further comprising a plurality of staging sites for holding the plurality of samples.

74. A system as defined in claim 68, wherein the light source comprises a laser, a laser diode or a light emitting diode (LED), and wherein the light source is configured to emit the excitation light at a modulation rate; and
wherein the modulation rate is selected based at least in part on the fluorescent lifetime of the fluorescent emission or phosphorescent emission associated with the fluorophore.

75. A system as defined in claim 68, wherein the signal indicative of the photo-response comprises a signal indicative of a response phase for the pixel, and wherein the response phase for a pixel is determined based at least in part by performing operations, the operations comprising:
determining a first response for the pixel from a first analog integrator;
determining a second response for the pixel using a second analog integrator;
determining the response phase based at least in part on the first response and the second response.

76. The system as defined in claim 75, wherein one or more processors are configured to determine the fluorescent lifetime based at least in part on the response phase.

77. A system as defined in claim 68, wherein the system further includes a tray that defines a plurality of sample staging sites, the system further comprising an array of plungers that move relative to the tray, the plungers being spaced apart so as to align with the sample staging sites on the tray, the plungers being configured to move towards the sample staging sites for contacting the biological material located in the sample staging sites, the plungers being in communication with the optical communication path for delivering the excitation light to the biological material and for delivering the fluorescent emission or phosphorescent emission produced by the fluorophore to the time-of-flight sensor.

78. A system as defined in claim 68, wherein the light source and the time-of-flight sensor operate at a frequency that permits multiple determinations of the fluorescent lifetime or the fluorescent intensity of the fluorophore in less than about 1 second.

79. A system as defined in claim 68, wherein the system includes a fluorophore source, and wherein the fluorophore source is configured to place a plurality of fluorophores in association with the biological material, and wherein the time-of-flight sensor and one or more processors are configured to determine the fluorescent lifetime or the fluorescent intensity of the plurality of fluorophores.

80. A system as defined in claim 68, wherein the time-of-flight sensor and one or more processors are configured to determine the fluorescent lifetime without calibrating the light source between testing of consecutive samples of the biological material.

81. A system as defined in claim 68, wherein the fluorescent emission or phosphorescent emission of the fluorophore is indicative of a parameter related to cellular metabolism, such as a dissolved gas, an ion, a protein, a metabolite, a nucleic acid, an enzyme, pH, an oxidation state, a viscosity, temperature, NAD(P)H, a salt, or a mineral.

82. A system as defined in claim 81, wherein the parameter comprises pH and wherein the flurophore exhibits a fluorescent lifetime of less than 5 nanoseconds.

83. A system as defined in claim 81, wherein the system is further configured to determine a concentration of the parameter or a rate of change of the parameter.

84. A method for analyzing biological material comprising:
exposing the biological material to excitation light in a manner that causes a fluorophore in association with the biological material to produce a fluorescent emission or phosphorescent emission;
communicating the fluorescent emission or phosphorescent emission to a time-of-flight sensor;
determining a fluorescence lifetime or a fluorescence intensity of the fluorophore; and
determining a magnitude characteristic of a biological parameter that is related to the determined fluorescent lifetime or the fluorescence intensity.

85. A method as defined in claim 84, wherein the biological material contains living cells comprising bacteria cells, fungus cells, yeast cells, prokaryotic cells, eukaryotic cells, animal cells, human cells, immune cells, or immortal cells.

86. A method as defined in claim 84, wherein the parameter comprises a dissolved gas, an ion, a protein, a metabolite, a nucleic acid, a lipid, a substrate, a salt, or a mineral.

87. A method as defined in claim 84, wherein a plurality of fluorophores are placed operative association with a corresponding plurality of samples of the biological material, each sample of the biological material being individually exposed to excitation light in a manner that causes a fluorophore in each sample of biological material to undergo the fluorescent emission or phosphorescent emission, and wherein the plurality of the fluorescent emissions or phosphorescent emissions are sensed and communicated to the time-of-flight sensor for determining the fluorescence lifetime or the fluorescence intensity of the fluorophore from each sample simultaneously.
